(19) United States
(12) Patent Application Publication
(10) Pub. No.: US 2026/0095906 A1
(43) Pub. Date: Apr. 2, 2026

(54) PHYSICAL LAYER CONCURRENCY MANAGEMENT FOR RADIO FREQUENCY IDENTIFICATION (RFID) AND WIRELESS WIDE AREA NETWORK (WWAN) COMMUNICATIONS

(71) Applicant: QUALCOMM Incorporated, San Diego, CA (US)

(72) Inventors: Venkatraman RAJAGOPALAN, San Diego, CA (US); Sheng-Yuan TU, San Diego, CA (US); Rishav REJ, Pleasanton, CA (US); Scott HOOVER, Del Mar, CA (US); Kiran PATIL, San Diego, CA (US); Arunava CHAUDHURI, San Diego, CA (US); Qingxin CHEN, San Diego, CA (US); Bhupesh Manoharlal UMATT, San Diego, CA (US); Joseph Patrick BURKE, Carlsbad, CA (US); Uttam PATTANAYAK, San Diego, CA (US)

(21) Appl. No.: 19/344,369

(22) Filed: Sep. 29, 2025

Related U.S. Application Data
(60) Provisional application No. 63/701,517, filed on Sep. 30, 2024.

(51) Int. Cl. H04W 72/12; H04W 72/0453; H04W 72/51

(52) U.S. Cl. CPC H04W 72/12; H04W 72/0453; H04W 72/51

(57) ABSTRACT

Disclosed are systems, apparatuses, processes, and computer-readable media for wireless communications. For example, a computing device can determine, based on constraints on resources of the computing device, a schedule for radio frequency identification (RFID) operations and wireless wide area network (WWAN) operations on the computing device. The resources can include compute resources and/or radio frequency (RF) component resources. The computing device can perform, based on the schedule, the RFID operations and the WWAN operations on the computing device.

### CROSS-REFERENCE TO RELATED APPLICATION

This application claims the benefit of U.S. Provisional Application No. 63/701,517, filed Sep. 30, 2024, which is hereby incorporated by reference, in its entirety and for all purposes.

### FIELD

Aspects of the present disclosure generally relate to wireless communications. For example, aspects of the present disclosure relate to physical layer concurrency management for radio frequency identification (RFID) and wireless wide area network (WWAN) communications.

### INTRODUCTION

Wireless communications systems are deployed to provide various telecommunication services, including telephony, video, data, messaging, broadcasts, among others. Wireless communications systems have developed through various generations, including a first-generation analog wireless phone service (1G), a second-generation (3G) high speed data, Internet-capable wireless service, a fourth-generation (4G) service (e.g., Long-Term Evolution (LTE), WiMax), and a fifth-generation (5G) service (e.g., New Radio (NR)).

Additional examples of wireless systems include RFID systems. In an RFID system, a device (a reader) may transmit wireless signals such as continuous wave (CW) signals to one or more RFID tags, which may be referred to as energy harvesting devices. One or more tags receive the transmitted energy and in turn transmit back signals to the device.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, apparatuses, methods and computer-readable media for wireless communications, such as for physical layer concurrency management for RFID and WWAN communications. In some aspects, an apparatus for wireless communications is provided. The apparatus includes a memory and a processor coupled to the memory and configured to: determine, based on constraints on resources of the apparatus, a schedule for radio frequency identification (RFID) operations and wireless wide area network (WWAN) operations on the apparatus, wherein the resources include at least one of compute resources or radio frequency (RF) component resources; and perform, based on the schedule, the RFID operations and the WWAN operations on the apparatus.

In some aspects, a method of wireless communications is provided. The method includes: determining, based on constraints on resources of a user device, a schedule for radio frequency identification (RFID) operations and wireless wide area network (WWAN) operations on the user device, wherein the resources include at least one of compute resources or radio frequency (RF) component resources; and performing, based on the schedule, the RFID operations and the WWAN operations on the user device.

In some aspects, a non-transitory computer-readable medium of a user device having stored thereon instructions that, when executed by at least one processor, cause the at least one processor to: determine, based on constraints on resources of the device, a schedule for radio frequency identification (RFID) operations and wireless wide area network (WWAN) operations on the device, wherein the resources include at least one of compute resources or radio frequency (RF) component resources; and perform, based on the schedule, the RFID operations and the WWAN operations on the device.

In some aspects, an apparatus for wireless communications is provided. The apparatus includes: means for determining, based on constraints on resources of the apparatus, a schedule for radio frequency identification (RFID) operations and wireless wide area network (WWAN) operations on the apparatus, wherein the resources include at least one of compute resources or radio frequency (RF) component resources; and means for performing, based on the schedule, the RFID operations and the WWAN operations on the apparatus.

Aspects generally include a method, apparatus, system, computer program product, non-transitory computer-readable medium, user device, user equipment, wireless communication device, and/or processing system as substantially described with reference to and as illustrated by the drawings and specification.

In some aspects, one or more of the apparatuses described herein is, can be part of, or can include a mobile device (e.g., a mobile telephone or so-called “smart phone”, a tablet computer, or other type of mobile device), an extended reality device (e.g., a virtual reality (VR) device, an augmented reality (AR) device, or a mixed reality (MR) device), a smart or connected device (e.g., an Internet-of-Things (IoT) device), a wearable device, a personal computer, a laptop computer, a video server, a vehicle (or a computing device, system, or component of a vehicle), a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and embodiments, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof.

FIG. 1 is a block diagram illustrating an example of a wireless communication network, in accordance with some examples;

FIG. 2 is a diagram illustrating a design of a base station and a User Equipment (UE) device that enable transmission and processing of signals exchanged between the UE and the base station, in accordance with some examples;

FIG. 3 is a diagram illustrating an example of a disaggregated base station, in accordance with some examples;

FIG. 4 is a block diagram illustrating components of a user equipment (UE), in accordance with some examples;

FIG. 5 is a diagram illustrating an example of a radio frequency (RF) energy harvesting device, in accordance with some examples;

FIG. 6 is a diagram illustrating an example of a small signal rectification operation that may be associated with performing energy harvesting, in accordance with some examples;

FIG. 7A is a diagram illustrating example energy harvesting characteristics between input power and harvested power, in accordance with some examples;

FIG. 7B is a diagram illustrating an example of energy conversion efficiency associated with different frequencies and input powers, in accordance with some examples;

FIG. 8 is a diagram illustrating an example of a radio frequency identification (RFID) inventory sequence, in accordance with some examples;

FIG. 9 is a diagram illustrating an example of a radio frequency identification (RFID) tones, in accordance with some examples;

FIGS. 10A and 10B illustrate a communication system that may implement DRX, in accordance with some examples;

FIGS. 11A and 11B are diagrams illustrating examples of combined WWAN and RFID communications, in accordance with some examples;

FIGS. 12A and 12B are diagrams illustrating examples of combined WWAN and RFID communications, in accordance with some examples;

FIGS. 13A, 13B, and 13C are diagrams illustrating examples of combined WWAN and RFID communications, in accordance with some examples;

FIGS. 14A, 14B, and 14C are diagrams illustrating examples of combined WWAN and RFID communications, in accordance with some examples;

FIG. 15 is a flowchart diagram illustrating an example of a process for wireless communications, in accordance with some examples; and

FIG. 16 is a diagram illustrating an example of a system for implementing certain aspects of the present technology, in accordance with some examples.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Wireless communication networks can be deployed to provide various communication services, such as voice, video, packet data, messaging, broadcast, any combination thereof, or other communication services. As explained herein, in some cases, wireless devices such as mobile devices may be utilized to simultaneously communicate with a wireless network and to concurrently interact with Internet-of-Things (IoT) devices. As further explained herein, such dual communication service and IoT functionality may be implemented within a single device or chipset, reusing antennas and/or compute capabilities, thereby lowering complexity, part cost, and power consumption.

A wireless communication network may support both access links and sidelinks for communications between wireless devices. An access link may refer to any communication link between a client device (e.g., a user equipment (UE), a station (STA), or other client device) and a base station (e.g., a 3GPP gNB for 5G/NR, a 3GPP eNB for 4G/LTE, a Wi-Fi access point (AP), or other base station). For example, an access link may support uplink signaling, downlink signaling, connection procedures, etc. An example of an access link is a Uu link or interface (also referred to as an NR-Uu) between a 3GPP gNB and a UE.

In various wireless communication networks, various client devices can be utilized that may be associated with different signaling and communication needs. For example, as 5G networks expand into industrial verticals and the quantity of deployed Internet-of-Things (IoT) devices grows, network service categories such as enhanced Mobile Broadband (eMBB), Ultra Reliable Low Latency Communications (URLLC), and massive Machine Type Communications (mMTC), etc., may be expanded to better support various IoT devices, which can include passive IoT devices, semi-passive IoT devices, etc. In some aspects, passive IoT devices may also be referred to as “ambient IoT devices.” For example, an ambient IoT device may be an IoT device that can perform ambient energy harvesting. An ambient IoT device may also be referred to as an ambient energy harvesting device. As used herein, the term “ambient IoT devices” may refer to active IoT devices, passive IoT devices, and/or semi-passive IoT devices.

Currently, radio frequency identification (RFID) protocols are being considered for inclusion in user devices (e.g., user equipment (UE)), such as a mobile device (e.g., a mobile phone such as a smartphone), a wearable device such as a smart watch, an extended reality (XR) device such as a virtual reality (VR) headset, an augmented reality (AR) headset or glasses, or a mixed reality (MR) headset, etc. RFID is a technology that is being considered to be added into the ecosystem of various types of user devices, including mobile phones. On a single user device, RFID operations should be able to run concurrently with existing wireless wide area network (WWAN) communications (e.g., new radio (NR), long-term evolution (LTE), third generation (3G), fourth generation (4G), fifth generation (5G), global system for mobile communications (GSM), and/or 1X wireless local area network (WLAN)) as an additional technology such that users can continue to operate WWAN communications on their user devices (e.g., mobile phones), while initiating RFID operations (e.g., for performing RFID transaction-related use cases).

When a user device (e.g., mobile phone or other user device) that is operating in WWAN communications (e.g., 4G or 5G) needs to initiate an RFID transaction, the user device's compute resources and radio frequency (RF) component resources (e.g., antennas, transceivers, filters, amplifiers, switches, etc.) may be shared for RFID operations. The compute resources required for RFID operations are not trivial and, as such, require significant compute processing on a modem of the user device. For example, RFID operations require processor compute and memory resources for processing and decoding RFID device (e.g., RFID tag) information. RFID operations also require RF component resources including at least one antenna for transmitting and receiving RFID signals to and from RFID devices.

As such, improved systems and techniques for WWAN operations and RFID operations to run concurrently on a single user device (e.g., mobile device such as a mobile phone) can be beneficial.

Systems and techniques are disclosed for physical layer concurrency management for radio frequency identification (RFID) and wireless wide area network (WWAN) communications. The systems and techniques provide solutions for concurrency management for RFID operations and WWAN operations that are directed to an integrated solution on a single user device (e.g., a mobile phone or other user device). For example, RFID operations and WWAN operations can operate concurrently on a single user device by sharing the compute resources (e.g., modem baseband resources) and the RF component resources in order to employ the same user device form factor.

An integrated solution can allow for better granular coordination between RFID and WWAN stacks, which can increase power efficiency for both technologies, as opposed to implementing independent solutions which can be costly and power heavy. Depending upon resource constraints (e.g., compute resources and RF component resources) of the mobile device, coordination between operation of the RFID and WWAN stacks can involve concurrent operation of the RFID and WWAN stacks or involve a time-division multiplexing (TDM) of the operation of the RFID and WWAN stacks (e.g., an RFID stack can operate, while a WWAN stack is not operating, and vice versa).

The solutions of the systems and techniques are directed to different scenarios that are related to whether resources (e.g., compute resources and RF component resources) of the user device are constrained. When one type of the resources (e.g., compute resources or RF component resources) of the user device is constrained, to accommodate the extra compute requirements for RFID operations, resource management paradigms can be utilized. One such resource management paradigm that may be employed involves dropping one WWAN communications technology completely (e.g., dropping NR or LTE). When a WWAN communications technology (e.g., NR or LTE) is completely dropped, compute resources and RF component resources can become available and, as such, RFID operations may then utilize these available resources.

Another resource management paradigm that can be used involves dropping a mode of a WWAN communications technology, such as dropping frequency range (FR) 1 or FR 2 in NR. Yet another resource management paradigm that may be used involves downgrading an envelope mode of a WWAN communications technology, such as reducing a number of frequency carriers (referred to as carriers) in NR or LTE (e.g., dropping a carrier in an interband-carrier aggregation (CA) configuration), which can allow for some radio frequency (RF) component resources (e.g., antennas, transceivers, filters, amplifiers, etc.) and compute resources to become available for RFID. When the resources (e.g., compute resources or RF component resources) of the user device are not constrained, both WWAN operations and RFID operations can run completely concurrently on the mobile device.

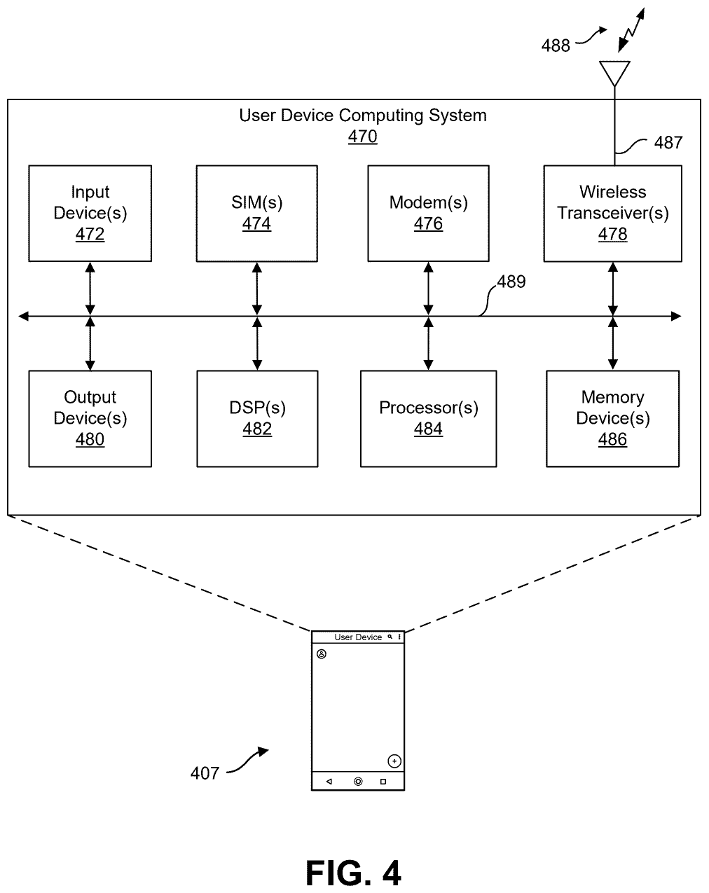

A device (e.g., a user device, such as the wireless device 407 of FIG. 4) can include one or more antennas and other RF component resources (e.g., transceivers, filters, amplifiers, etc.). The device can include an SSIM or MSIM. When the device includes an SSIM, the device can include an RFID stack and a WWAN stack. When the device includes MSIM, the device can include an RFID stack and multiple WWAN stacks (e.g., where the number of WWAN stacks depends upon the number of subscriber identity modules (SIMs) within the device). The RFID stack of the device can perform RFID communications (e.g., via one or more RFID signals) with one or more RFID devices. Each WWAN stack of the device can perform one or more WWAN sessions (e.g., a WWAN communication session to communicate) with one or more network entities, such as a base station.

An apparatus for wireless communications can include a memory. The apparatus can further include a processor coupled to the memory. The processor can be configured to determine, based on constraints on resources of the apparatus, a schedule for radio frequency identification (RFID) operations (e.g., RFID communications) and wireless wide area network (WWAN) operations (e.g., WWAN communications) on the apparatus. The resources can include compute resources and RF component resources. The processor can be configured to perform, based on the schedule, the RFID operations and the WWAN operations on the apparatus.

The processor can be further configured to determine the schedule based on whether the apparatus comprises a single subscriber identity module (SSIM) or multiple subscriber identity modules (MSIM). When the apparatus includes the MSIM, the WWAN operations can include first WWAN operations and second WWAN operations. Based on the resources being constrained, the schedule can indicate performance of the WWAN operations using new radio (NR) communications or long-term evolution (LTE) communications. Based on the resources being constrained, the schedule can indicate performance of the WWAN operations using frequency range one (FR1) or frequency range two (FR2) of new radio (NR) communications. Based on the resources being constrained, the schedule can indicate performance of the WWAN operations using a reduced number of carriers from a total number of carriers available for WWAN communications. The schedule can indicate performance of the RFID operations during one or more sleep durations for the WWAN operations. The schedule can indicate performance of the RFID operations during one or more paging intervals for the WWAN operations.

The processor can be further configured to determine the schedule based on performance of the RFID operations having priority over performance of the WWAN operations. The RFID operations can include RFID receive operations and RFID transmit operations, and the WWAN operations can include WWAN receive operations or WWAN transmit operations. The schedule can indicate time division multiplexing (TDM) of the RFID operations and the WWAN operations. The schedule can indicate at least some simultaneous performance of the RFID operations and the WWAN operations. The RF component resources can include one or more antennas, one or more filters, one or more amplifiers (e.g., low noise amplifiers (LNAs), one or more transceivers, one or more switches, among others. Examples described herein refer to configuring or reconfiguring antennas as a specific example of an RF component resource. However, such examples can also apply to configuring or reconfiguring other types of RF component resources, such as filters, amplifiers, transceivers, switches, etc. The compute resources can include modem baseband resources. The apparatus can be user equipment (UE), such as a mobile device, for example a smartphone.

According to at least one illustrative example, a wireless device (e.g., a UE) can configure a first antenna and a second antenna to communicate Wireless Wide Area Network (WWAN) signals. As used herein, “configuring an antenna” or “reconfiguring an antenna” includes adjusting or tuning the receive and/or transmit chains through which a baseband signal is translated from or to a signal compatible with the antenna, and/or includes programming additional functionality, such as impedance and/or antenna aperture tuners to align the antenna to a frequency band of interest. The wireless device can establish a WWAN session with a network entity (e.g., a base station or a portion of a base station, such as a central unit (CU), a distributed unit (DU), a radio unit (RU), a Near-Real Time (Near-RT) RAN Intelligent Controller (RIC), or a Non-Real Time (Non-RT) RIC of a disaggregated base station). During a first period of time, the wireless device can cause the first antenna to communicate one or more first WWAN signals with the network entity. The wireless device can reconfigure the first antenna to communicate Radio Frequency Identification (RFID) signals, such as for energizing and/or transmitting information to one or more RFID-based IoT devices (e.g., one or more RFID tags or other IoT devices). During a second period of time, the wireless device can cause the first antenna to emit an RFID inventory sequence and can cause the second antenna to communicate one or more second WWAN signals with the network entity.

During operation of a method for wireless communications at a device, one or more processors of the device can configure the one or more antennas of the device to receive and/or transmit one or more WWAN signals, which are radio frequency (RF) signals. The one or more processors of the device can establish each WWAN session of one or more WWAN sessions with a respective network entity (e.g., a base station). During a first period of time, the one or more processors of the device can cause each antenna of the one or more antennas to communicate a respective WWAN signal of the one or more WWAN signals with a respective network entity of the respective network entities. The one or more processors of the device can reconfigure at least one antenna of the one or more antennas to communicate one or more RFID signals (e.g., RF signals). During a second period of time, the one or more processors of the device can cause the at least one antenna of the one or more antennas to communicate the one or more RFID signals with one or more RFID devices, such as RFID tags (e.g., which may be energy harvesting devices that include no battery).

The one or more processors can disconnect the one or more WWAN sessions prior to reconfiguring the at least one antenna to communicate the one or more RFID signals. The disconnecting of the one or more WWAN sessions can include the one or more processors to force a radio link failure in a download or to cease an upload.

The first period of time can correspond to the one or more WWAN sessions operating in an idle mode for receiving the one or more WWAN signals or can correspond to the one or more WWAN sessions operating in a connected mode for transmitting the one or more WWAN signals. When the first period of time corresponds to the one or more WWAN sessions operating in the idle mode, the second period of time (e.g., for slotting the communications of the RFID signals) can be during a Wide Area Network (WAN) paging interval duration or during a WAN extended discontinuous reception (EDRX) sleep duration. When the first period of time corresponds to the one or more WWAN sessions operating in the connected mode, the second period of time can be during a connected discontinuous reception (CRDX) sleep duration.

The communicating of the one or more RFID signals via the at least one antenna can include transmitting an RFID signal of the one or more RFID signals to an RFID energy harvesting device (e.g., an RFID tag). The RFID signal of the one or more RFID signals can be a RFID continuous wave (CW) transmission, one or more RFID data modulated signals, or other transmission or signals to power the RFID energy harvesting device.

Further aspects of the systems and techniques will be described with respect to the figures.

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), aircraft (e.g., an airplane, jet, unmanned aerial vehicle (UAV) or drone, helicopter, airship, glider, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.), and so on.

A network entity can be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, or a forward traffic channel, etc.). The term traffic channel (TCH), as used herein, can refer to either an uplink, reverse or downlink, and/or a forward traffic channel.

The term “network entity” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (e.g., a network of spatially separated antennas connected to a common source via a transport medium) or a remote radio head (RRH) (e.g., a remote base station connected to a serving base station). Alternatively, the non-co-located physical TRPs may be the serving base station receiving the measurement report from the UE and a neighbor base station whose reference radio frequency (RF) signals (e.g., or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

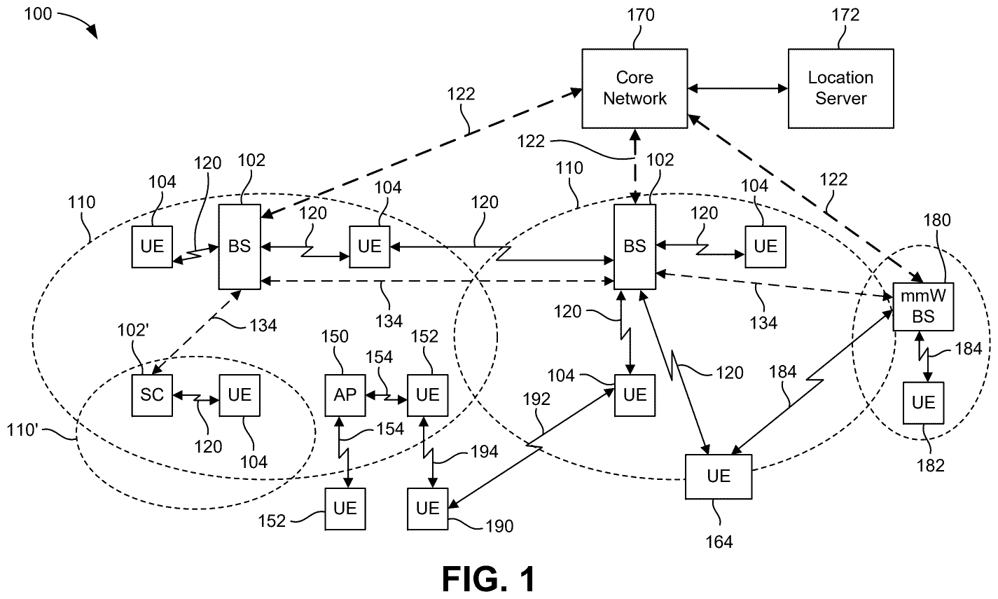

Various aspects of the systems and techniques described herein will be discussed below with respect to the figures. According to various aspects, FIG. 1 illustrates an example of a wireless communications system 100. The wireless communications system 100 (e.g., which may also be referred to as a wireless wide area network (WWAN)) can include various base stations 102 and various UEs 104. In some aspects, the base stations 102 may also be referred to as “network entities” or “network nodes.” One or more of the base stations 102 can be implemented in an aggregated or monolithic base station architecture. Additionally, or alternatively, one or more of the base stations 102 can be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 can include macro cell base stations (e.g., high power cellular base stations) and/or small cell base stations (e.g., low power cellular base stations). In an aspect, the macro cell base station may include eNBs and/or ng-eNBs where the wireless communications system 100 corresponds to a long-term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (e.g., also referred to as reverse link) transmissions from a UE 104 to a base station 102 and/or downlink (e.g., also referred to as forward link) transmissions from a base station 102 to a UE 104. The communication links 120 may use MIMO antenna technology, including spatial multiplexing, beamforming, and/or transmit diversity. The communication links 120 may be provided using one or more carrier frequencies. Allocation of carriers may be asymmetric with respect to downlink and uplink (e.g., a greater or lesser quantity of carriers may be allocated for downlink than for uplink).

Beamforming, which may also be referred to as spatial filtering, directional transmission, or directional reception, is a signal processing technique that may be used at a transmitting device or a receiving device (e.g., one or more of the base stations 102, UEs 104, etc.) to shape or steer an antenna beam (e.g., a transmit beam, a receive beam) along a spatial path between the transmitting device and the receiving device. Beamforming may be implemented based on combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A transmitting device and/or a receiving device (e.g., such as one or more of base stations 102 and/or UEs 104) may use beam sweeping techniques as part of beam forming operations. For example, a base station 102 (e.g., or other transmitting device) may use multiple antennas or antenna arrays (e.g., antenna panels) to conduct beamforming operations for directional communications with a UE 104 (e.g., or other receiving device). Some signals (e.g., synchronization signals, reference signals, beam selection signals, or other control signals) may be transmitted by base station 102 (or other transmitting device) multiple times in different directions. For example, the base station 102 may transmit a signal according to different beamforming weight sets associated with different directions of transmission. Transmissions in different beam directions may be used to identify (e.g., by a transmitting device, such as a base station 102, or by a receiving device, such as a UE 104) a beam direction for later transmission or reception by the base station 102.

Some signals, such as data signals associated with a particular receiving device, may be transmitted by a base station 102 in a single beam direction (e.g., a direction associated with the receiving device, such as a UE 104). The beam direction associated with transmissions along a single beam direction may be determined based on a signal that was transmitted in one or more beam directions. For example, a UE 104 may receive one or more of the signals transmitted by the base station 102 in different directions and may report to the base station 102 an indication of the signal that the UE 104 received with a highest signal quality or an otherwise acceptable signal quality.

Transmissions by a device (e.g., by a base station 102 or a UE 104) may be performed using multiple beam directions, and the device may use a combination of digital precoding or radio frequency beamforming to generate a combined beam for transmission (e.g., from a base station 102 to a UE 104, from a transmitting device to a receiving device, etc.). The UE 104 may report feedback that indicates precoding weights for one or more beam directions, and the feedback may correspond to a configured number of beams across a system bandwidth or one or more sub-bands. The base station 102 may transmit a reference signal (e.g., a cell-specific reference signal (CRS), a channel state information reference signal (CSI-RS), etc.), which may be precoded or unprecoded. The UE 104 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 102, a UE 104 may employ similar techniques for transmitting signals multiple times in different directions (e.g., for identifying a beam direction for subsequent transmission or reception by the UE 104) or for transmitting a signal in a single direction (e.g., for transmitting data to a receiving device).

A receiving device (e.g., a UE 104) may try multiple receive configurations (e.g., directional listening) when receiving various signals from the base station 102, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. A receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. The wireless communications system 100 can include devices (e.g., UEs, etc.) that communicate with one or more UEs 104, base stations 102, APs 150, etc., utilizing the ultra-wideband (UWB) spectrum. The UWB spectrum can range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (e.g., transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FR1 (e.g., from 450 to 6,000 Megahertz (MHz)), FR2 (e.g., from 24,250 to 52,600 MHz), FR3 (e.g., above 52,600 MHz), and FR4 (e.g., between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (e.g., whether a PCell or an SCell) corresponds to a carrier frequency and/or component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (e.g., x component carriers) for transmission in each direction. The component carriers may or may not be adjacent to each other on the frequency spectrum. Allocation of carriers may be asymmetric with respect to the downlink and uplink (e.g., a greater or lesser quantity of carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (e.g., 40 MHz), compared to that attained by a single 20 MHz carrier.

In order to operate on multiple carrier frequencies, a base station 102 and/or a UE 104 can be equipped with multiple receivers and/or transmitters. For example, a UE 104 may have two receivers, “Receiver 1” and “Receiver 2,” where “Receiver 1” is a multi-band receiver that can be tuned to band (e.g., carrier frequency) ‘X’ or band ‘Y,’ and “Receiver 2” is a one-band receiver tunable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (e.g., an SCell) in order to measure band ‘Y’ (and vice versa). In contrast, whether the UE 104 is being served in band ‘X’ or band ‘Y,’ because of the separate “Receiver 2,” the UE 104 can measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (e.g., referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (e.g., through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

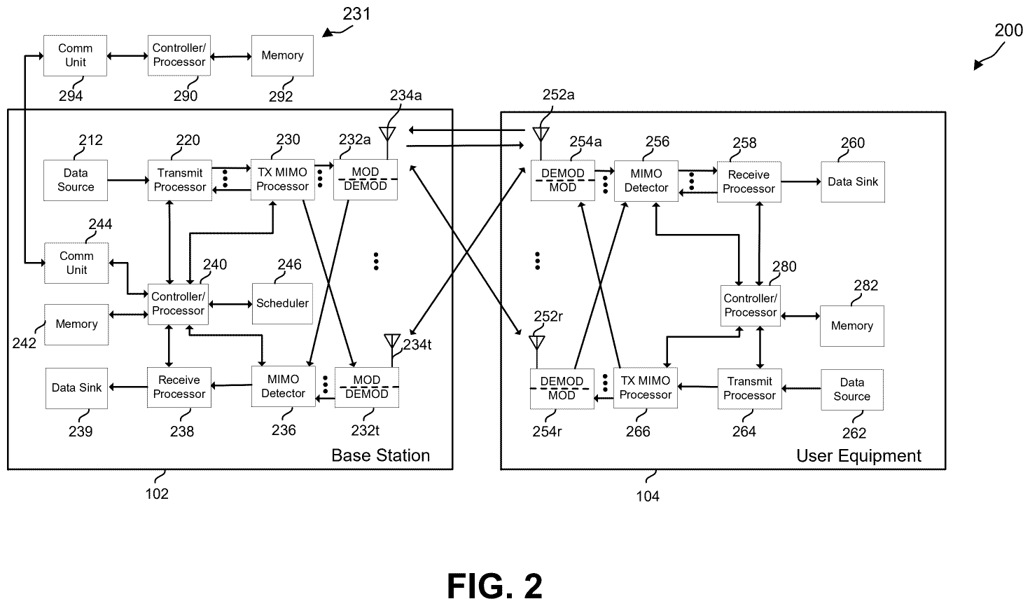

FIG. 2 illustrates a block diagram of an example architecture 200 of a base station 102 and a UE 104 that enables transmission and processing of signals exchanged between the UE and the base station. Example architecture 200 includes components of a base station 102 and a UE 104, which may be one of the base stations 102 and one of the UEs 104 illustrated in FIG. 1. Base station 102 may be equipped with T antennas 234a through 234t, and UE 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based on channel quality indicators (CQIs) received from the UE, process (e.g., encode and modulate) the data for each UE based on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. The modulators 232a through 232t are shown as a combined modulator-demodulator (MOD-DEMOD). In some cases, the modulators and demodulators can be separate components. Each modulator of the modulators 232a to 232t may process a respective output symbol stream (e.g., for an orthogonal frequency-division multiplexing (OFDM) scheme and/or the like) to obtain an output sample stream. Each modulator of the modulators 232a to 232t may further process (e.g., convert to analog, amplify, filter, and upconvert) the output sample stream to obtain a downlink signal. T downlink signals may be transmitted from modulators 232a to 232t via T antennas 234a through 234t, respectively. According to certain aspects described in more detail below, the synchronization signals can be generated with location encoding to convey additional information.

At UE 104, antennas 252a through 252r may receive the downlink signals from base station 102 and/or other base stations and may provide received signals to one or more demodulators (DEMODs) 254a through 254r, respectively. The demodulators 254a through 254r are shown as a combined modulator-demodulator (MOD-DEMOD). In some cases, the modulators and demodulators can be separate components. Each demodulator of the demodulators 254a through 254r may condition (e.g., filter, amplify, downconvert, and digitize) a received signal to obtain input samples. Each demodulator of the demodulators 254a through 254r may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 104, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals (e.g., based on a beta value or a set of beta values associated with the one or more reference signals). The symbols from transmit processor 264 may be precoded by a TX-MIMO processor 266, further processed by modulators 254a through 254r (e.g., for DFT-s-OFDM, CP-OFDM, and/or the like), and transmitted to base station 102. At base station 102, the uplink signals from UE 104 and other UEs may be received by antennas 234a through 234t, processed by demodulators 232a through 232t, detected by a MIMO detector 236 (e.g., if applicable), and further processed by a receive processor 238 to obtain decoded data and control information sent by UE 104. Receive processor 238 may provide the decoded data to a data sink 239 and the decoded control information to controller (e.g., processor) 240. Base station 102 may include communication unit 244 and communicate to a network controller 231 via communication unit 244. Network controller 231 may include communication unit 294, controller/processor 290, and memory 292.

In some aspects, one or more components of UE 104 may be included in a housing. Controller 240 of base station 102, controller/processor 280 of UE 104, and/or any other component(s) of FIG. 2 may perform one or more techniques associated with implicit UCI beta value determination for NR.

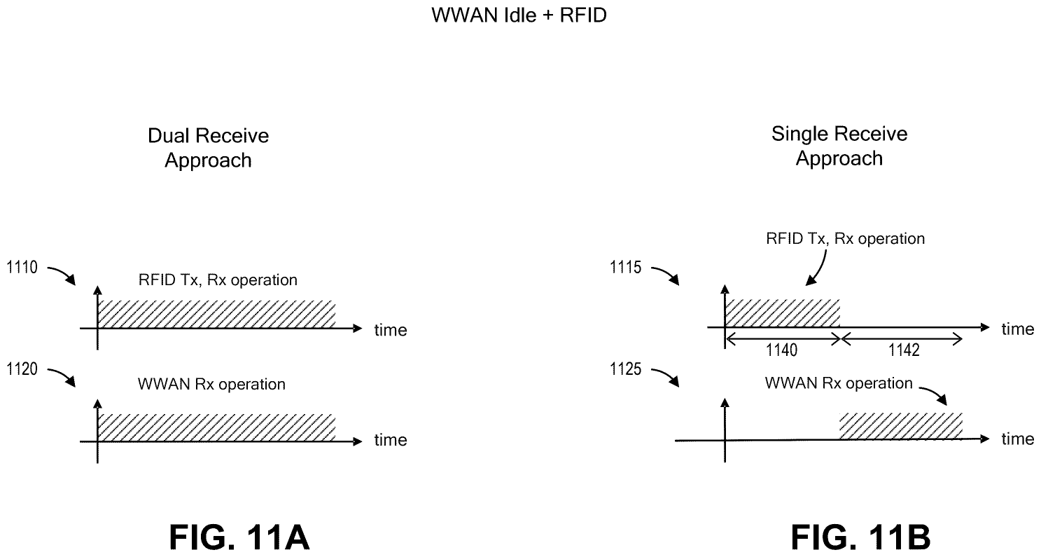

Memories 242 and 282 may store data and program codes for the base station 102 and the UE 104, respectively. A scheduler 246 may schedule UEs for data transmission on the downlink, uplink, and/or sidelink. For example, as described with respect to FIGS. 11A-14C, RFID and WWAN operations or communications can be scheduled on various time slots.

In some aspects, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (e.g., such as a Node B (NB), evolved NB (eNB), NR BS, 5G NB, access point (AP), a transmit receive point (TRP), or a cell, etc.) may be implemented as an aggregated base station (e.g., also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (e.g., such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (e.g., such as the network configuration sponsored by the O-RAN Alliance)), or a virtualized radio access network (e.g., vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

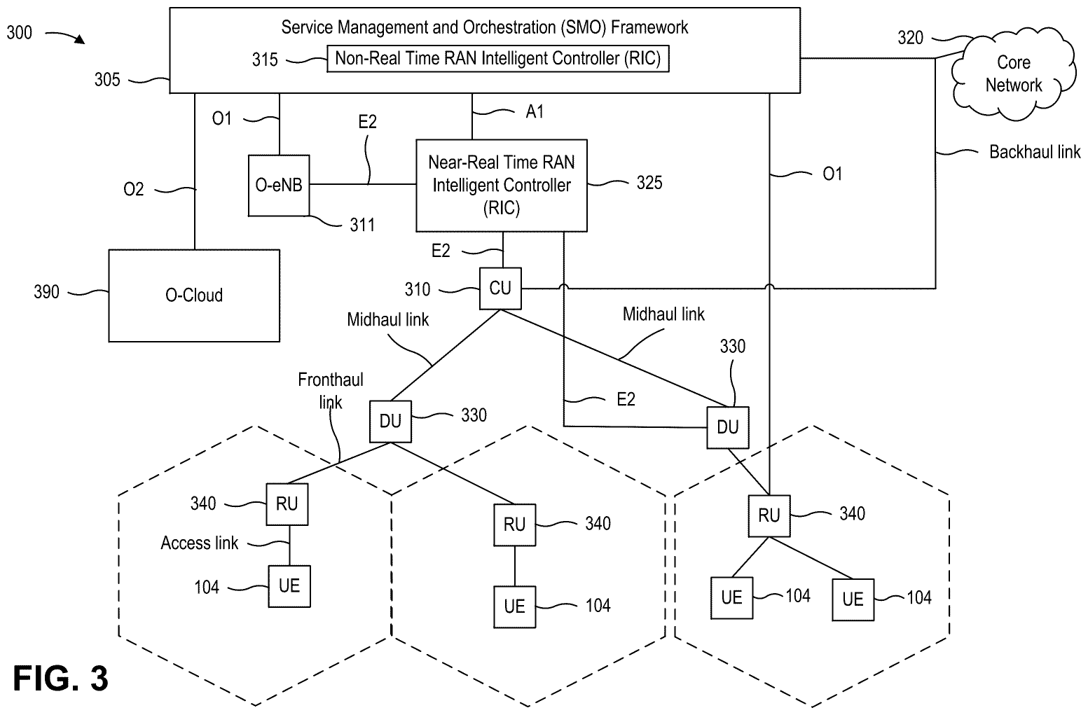

FIG. 3 is a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (e.g., such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 104 via one or more radio frequency (RF) access links. In some implementations, the UE 104 may be simultaneously served by multiple RUs 340.

Each of the units (e.g., the CUs 310, the DUs 330, the RUs 340, as well as the Near-RT RICs 325, the Non-RT RICs 315, and the SMO Framework 305) illustrated in FIG. 3 and/or described herein may include one or more interfaces or be coupled to one or more interfaces configured to receive or transmit signals, data, or information (e.g., collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (e.g., such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (e.g., such as modules for forward error correction (FEC) encoding and decoding, scrambling, modulation and demodulation, or the like) depending on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (e.g., such as performing fast Fourier transform (FFT), inverse FFT (iFFT), digital beamforming, physical random-access channel (PRACH) extraction and filtering, or the like), or both, based on the functional split, such as a lower layer functional split. In such an architecture, the RU(s) 340 can be implemented to handle over the air (OTA) communication with one or more UEs 104. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (e.g., such as an O1 interface). For virtualized network elements, the SMO Framework 305 may be configured to interact with a cloud computing platform (e.g., such as an open cloud (O-Cloud) 390) to perform network element life cycle management (e.g., such as to instantiate virtualized network elements) via a cloud computing platform interface (e.g., such as an O2 interface). Such virtualized network elements can include, but are not limited to, CUs 310, DUs 330, RUs 340, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (e.g., such as via an A1 interface) the Near-RT RIC 325. The Near-RT RIC 325 may be configured to include a logical function that enables near-real-time control and optimization of RAN elements and resources via data collection and actions over an interface (e.g., such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. The Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (e.g., such as reconfiguration via 01) or via creation of RAN management policies (e.g., such as A1 policies).

FIG. 4 illustrates an example of a computing system 470 of a wireless device 407. The wireless device 407 may include a client device such as a UE (e.g., UE 104, UE 152, UE 190) or other type of device (e.g., a station (STA) configured to communication using a Wi-Fi interface) that may be used by an end-user. For example, the wireless device 407 may include a mobile phone, router, tablet computer, laptop computer, tracking device, wearable device (e.g., a smart watch, glasses, an extended reality (XR) device such as a virtual reality (VR), augmented reality (AR), or mixed reality (MR) device, etc.), Internet of Things (IoT) device, a vehicle, an aircraft, and/or another device that is configured to communicate over a wireless communications network. The computing system 470 includes software and hardware components that may be electrically or communicatively coupled via a bus 489 (e.g., or may otherwise be in communication, as appropriate). For example, the computing system 470 includes one or more processors 484. The one or more processors 484 may include one or more CPUs, ASICs, FPGAs, APs, GPUs, VPUs, NSPs, microcontrollers, dedicated hardware, any combination thereof, and/or other processing device or system. The bus 489 may be used by the one or more processors 484 to communicate between cores and/or with the one or more memory devices 486.

The computing system 470 may also include one or more memory devices 486, one or more digital signal processors (DSPs) 482, one or more SIMs 474, one or more modems 476, one or more wireless transceivers 478, an antenna 487, one or more input devices 472 (e.g., a camera, a mouse, a keyboard, a touch sensitive screen, a touch pad, a keypad, a microphone, and/or the like), and one or more output devices 480 (e.g., a display, a speaker, a printer, and/or the like).

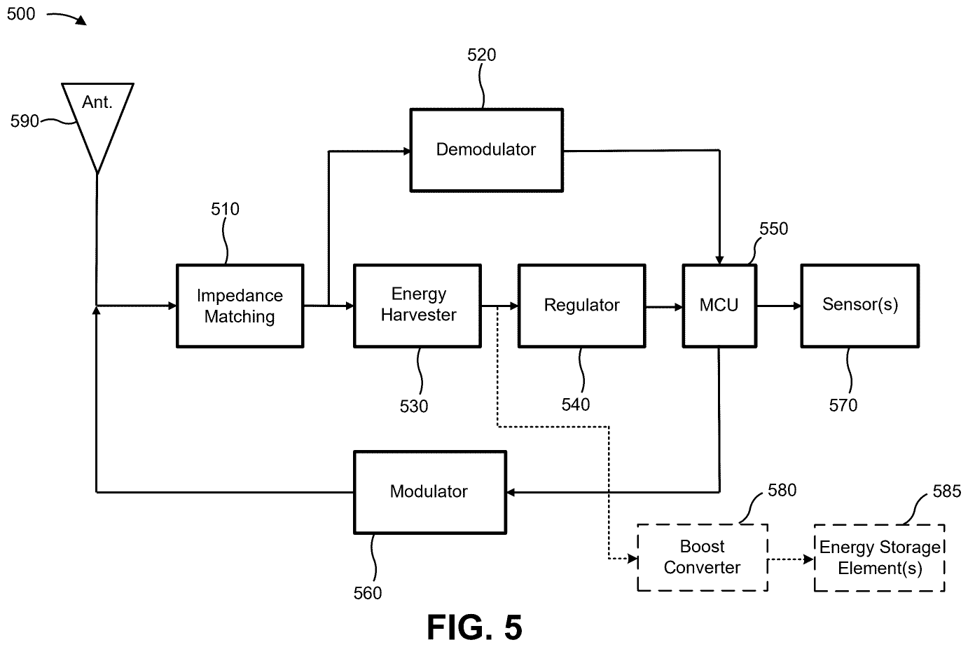

In some aspects, computing system 470 may include one or more radio frequency (RF) interfaces configured to transmit and/or receive RF signals. An RF interface may include components such as modem(s) 476, wireless transceiver(s) 478, and/or antennas 487. The one or more wireless transceivers 478 may transmit and receive wireless signals (e.g., signal 488) via antenna 487 from one or more other devices, such as other wireless devices, network devices (e.g., base stations such as eNBs and/or gNBs, Wi-Fi access points (APs) such as routers, range extenders or the like, etc.), cloud networks, and/or the like. The computing system 470 may include multiple antennas or an antenna array that may facilitate simultaneous transmit and receive functionality. Antenna 487 may be an omnidirectional antenna such that radio frequency (RF) signals may be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a Wi-Fi network), a Bluetooth™ network, and/or other network. In some cases, the antenna may be configured to emit continuous wave communications that can stimulate energy in an energy harvesting device (e.g., a RFID tag) such as energy harvesting device 500 shown in FIG. 5. In some cases, the antenna may be configured to receive RFID communications from such an energy harvesting device.

The wireless signal 488 may be transmitted directly to other wireless devices using sidelink communications (e.g., using a PC5 interface, using a DSRC interface, etc.). Wireless transceivers 478 may be configured to transmit RF signals for performing sidelink communications via antenna 487 in accordance with one or more transmit power parameters that may be associated with one or more regulation modes. Wireless transceivers 478 may also be configured to receive sidelink communication signals having different signal parameters from other wireless devices.

The one or more wireless transceivers 478 may include an RF front end including one or more components, such as an amplifier, a mixer (e.g., also referred to as a signal multiplier) for signal down conversion, a frequency synthesizer (e.g., also referred to as an oscillator) that provides signals to the mixer, a baseband filter, an analog-to-digital converter (ADC), one or more power amplifiers, among other components. The RF front-end may generally handle selection and conversion of the wireless signals 488 into a baseband or intermediate frequency and may convert the RF signals to the digital domain.

In some cases, the computing system 470 may include a coding-decoding device (or CODEC) configured to encode and/or decode data transmitted and/or received using the one or more wireless transceivers 478. In some cases, the computing system 470 may include an encryption-decryption device or component configured to encrypt and/or decrypt data (e.g., according to the AES and/or DES standard) transmitted and/or received by the one or more wireless transceivers 478.

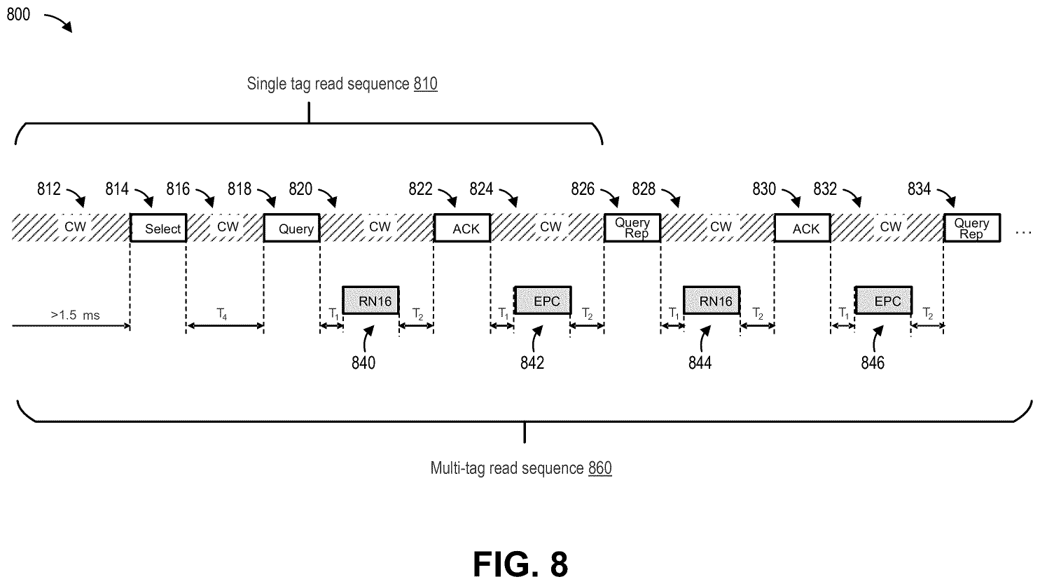

The one or more SIMs 474 may each securely store an international mobile subscriber identity (IMSI) number and related key assigned to the user of the wireless device 407. The IMSI and key may be used to identify and authenticate the subscriber when accessing a network provided by a network service provider or operator associated with the one or more SIMs 474. The one or more modems 476 may modulate one or more signals to encode information for transmission using the one or more wireless transceivers 478. The one or more modems 476 may also demodulate signals received by the one or more wireless transceivers 478 in order to decode the transmitted information. The one or more modems 476 may include a Wi-Fi modem, a 4G (or LTE) modem, a 5G (or NR) modem, and/or other types of modems. The one or more modems 476 and the one or more wireless transceivers 478 may be used for communicating data for the one or more SIMs 474. The one or more wireless transceivers 478 may be able to process or modulate signals such as continuous wave signals and/or receive and demodulate signals received from an RFID tag or energy harvesting device. An example of RFID signals is shown further with respect to FIG. 8.

The computing system 470 may also include (and/or be in communication with) one or more non-transitory machine-readable storage media or storage devices (e.g., one or more memory devices 486), which may include, without limitation, local and/or network accessible storage, a disk drive, a drive array, an optical storage device, a solid-state storage device such as a RAM and/or a ROM, which may be programmable, flash-updateable, and/or the like. Such storage devices may be configured to implement any appropriate data storage, including without limitation, various file systems, database structures, and/or the like.

In various aspects, functions may be stored as one or more computer-program products (e.g., instructions or code) in memory device(s) 486 and executed by the one or more processor(s) 484 and/or the one or more DSPs 482. The computing system 470 may also include software elements (e.g., located within the one or more memory devices 486), including, for example, an operating system, device drivers, executable libraries, and/or other code, such as one or more application programs, which may comprise computer programs implementing the functions provided by various aspects, and/or may be designed to implement methods and/or configure systems, as described herein.

Ambient IoT devices (e.g., active IoT devices, passive IoT devices, semi-passive IoT devices, etc.) are relatively low-cost UEs that may be used to implement one or more sensing and communication capabilities in an IoT network or deployment. Passive and/or semi-passive IoT sensors (e.g., devices) can be used to provide sensing capabilities for various processes and use cases, such as asset management, logistics, warehousing, manufacturing, etc. Passive and semi-passive IoT devices can include one or more sensors, a processor or micro-controller, and an energy harvester for generating electrical power from incident downlink radio frequency (RF) signals received at the passive or semi-passive IoT device.

Based on harvesting energy from incident downlink RF signals (e.g., transmitted by an energy source network device such as a base station, gNB, etc.), ambient energy harvesting devices (e.g., ambient IoT devices) may be provided without an energy storage element and/or can be provided with a relatively small energy storage element (e.g., battery, capacitor, etc.) Ambient energy harvesting devices provided without an energy storage element may include passive IoT devices. Ambient energy harvesting devices provided with a relatively small energy storage element may include semi-passive IoT devices. Ambient energy harvesting devices that are provided with an energy storage element may include active IoT devices. Energy harvesting devices can be deployed at large scales, based on the simplification in their manufacture and deployment associated with implementing wireless energy harvesting.

Ambient energy harvesting devices can harvest energy from dedicated downlink RF signals for energy harvesting. In some cases, an ambient energy harvesting device may be configured to perform energy harvesting only for dedicated downlink RF signals for energy harvesting. In some cases, ambient energy harvesting devices can harvest energy from ambient downlink RF signals (e.g., including dedicated downlink RF signals for energy harvesting and various other downlink RF signals that are not dedicated energy harvesting signals).

In some cases, an ambient energy harvesting device can use the same antenna for energy harvesting and communications. For example, an ambient energy harvesting device can use the same antenna to perform energy harvesting and backscatter communications, where the energy harvesting and the backscatter communications are based on the same downlink RF signal. An ambient energy harvesting device can include a first antenna used for energy harvesting and a second antenna used for communications, where the first antenna is different from the second antenna. For instance, an ambient IoT device can use the first antenna to perform energy harvesting and can use the second antenna to perform communication (e.g., transmitting and/or receiving).

The backscatter transmitter can generate and transmit an uplink signal by reflecting and backscatter modulating an incident downlink signal using the first antenna. An ambient IoT device can use a backscatter transmitter that is the same as or similar to a backscatter transmitter utilized by a passive or semi-passive IoT device, as described above. An active transmitter can use a battery or other energy storage element included in the ambient IoT device to generate and transmit an uplink signal, using an antenna that is different from the first antenna associated with the backscatter transmitter (e.g., a second antenna). To transmit an uplink signal, the backscatter transmitter of an ambient IoT device must first receive a downlink signal that can be reflected and backscatter modulated. For example, the backscatter transmitter may be unable to transmit an uplink signal unless or until a continuous sine wave is received as a downlink signal from a base station, gNB, or other energy source network device. The active transmitter of an ambient IoT device can perform uplink communication that is triggered by the ambient IoT device (e.g., without dependence on first receiving a downlink signal). Ambient IoT devices may include a small battery or energy storage element and may be unable to sustain longer periods of uplink communication using the active transmitter of the ambient IoT device. For example, active transmission by an ambient IoT device may quickly deplete the onboard battery or other energy storage element(s) included in the ambient IoT device.

FIG. 5 is a diagram illustrating an example of an architecture of a radio frequency (RF) energy harvesting device 500. As will be described in greater depth below, the RF energy harvesting device 500 can harvest RF energy from one or more RF signals received using an antenna 590. As used herein, the term “energy harvesting” may be used interchangeably with “power harvesting.” In some aspects, energy harvesting device 500 can be implemented as an Internet-of-Things (IoT) device, can be implemented as a sensor, etc., as will be described in greater depth below. In other examples, energy harvesting device 500 can be implemented as a Radio-Frequency Identification (RFID) tag or various other RFID devices.

The energy harvesting device 500 includes one or more antennas 590 that can be used to transmit and receive one or more wireless signals. For example, energy harvesting device 500 can use antenna(s) 590 to receive one or more downlink signals and to transmit one or more uplink signals. An impedance matching component 510 can be used to match the impedance of antenna(s) 590 to the impedance of one or more (or all) of the receive components included in energy harvesting device 500. The receive components of energy harvesting device 500 can include a demodulator 520 (e.g., for demodulating a received downlink signal), an energy harvester 530 (e.g., for harvesting RF energy from the received downlink signal), a regulator 540, a micro-controller unit (MCU) 550, a modulator 560 (e.g., for generating an uplink signal). In some cases, the receive components of energy harvesting device 500 may further include one or more sensors 570.

The downlink signals can be received from one or more transmitters. For example, energy harvesting device 500 may receive a downlink signal from a network node or network entity that is included in a same wireless network as the energy harvesting device 500. In some cases, the network entity can be a base station, gNB, etc., that communicates with the energy harvesting device 500 using a cellular communication network. For example, the cellular communication network can be implemented according to the 3G, 4G, 5G, and/or other cellular standard (e.g., including future standards such as 6G and beyond).

In some cases, energy harvesting device 500 can be implemented as a passive or semi-passive energy harvesting device (e.g., an ambient energy harvesting device), which can perform passive uplink communication by modulating and reflecting a downlink signal received via antenna(s) 590. For example, passive and semi-passive energy harvesting devices may be unable to generate and transmit an uplink signal without first receiving a downlink signal that can be modulated and reflected. In other examples, energy harvesting device 500 may be implemented as an active energy harvesting device, which utilizes a powered transceiver to perform active uplink communication. An active energy harvesting device is able to generate and transmit an uplink signal without first receiving a downlink signal (e.g., by using an on-device power source to energize its powered transceiver).

An ambient energy harvesting device (e.g., active or semi-passive energy harvesting device) may include one or more energy storage elements 585 (e.g., collectively referred to as an “energy reservoir”). For example, the one or more energy storage elements 585 can include batteries, capacitors, etc. The one or more energy storage elements 585 may be associated with a boost converter 580. The boost converter 580 can receive as input at least a portion of the energy harvested by energy harvester 530 (e.g., with a remaining portion of the harvested energy being provided as instantaneous power for operating the energy harvesting device 500). In some aspects, the boost converter 580 may be a step-up converter that steps up voltage from its input to its output (e.g., and steps down current from its input to its output). Boost converter 580 can be used to step up the harvested energy generated by energy harvester 530 to a voltage level associated with charging the one or more energy storage elements 585. An ambient energy harvesting device (e.g., active or semi-passive energy harvesting device) may include one or more energy storage elements 585 and may include one or more boost converters 580. A quantity of energy storage elements 585 may be the same as or different than a quantity of boost converters 580 included in an active or semi-passive energy harvesting device.

A passive energy harvesting device does not include an energy storage element 585 or other on-device power source. For example, a passive energy harvesting device may be powered using only RF energy harvested from a downlink signal (e.g., using energy harvester 530). As mentioned previously, a semi-passive energy harvesting device can include one or more energy storage elements 585 and/or other on-device power sources. The energy storage element 585 of a semi-passive energy harvesting device can be used to augment or supplement the RF energy harvested from a downlink signal. In some cases, the energy storage element 585 of a semi-passive energy harvesting device may store insufficient energy to transmit an uplink communication without first receiving a downlink communication (e.g., minimum transmit power of the semi-passive device>capacity of the energy storage element). An active energy harvesting device can include one or more energy storage elements 585 and/or other on-device power sources that can power uplink communication without using supplemental harvested RF energy (e.g., minimum transmit power of the active device<capacity of the energy storage element). The energy storage element(s) 585 included in an active energy harvesting device and/or a semi-passive energy harvesting device can be charged using harvested RF energy.

As mentioned above, ambient energy harvesting devices (e.g., passive and semi-passive energy harvesting devices) transmit uplink communications by performing backscatter modulation to modulate and reflect a received downlink signal. The received downlink signal is used to provide both electrical power (e.g., to perform demodulation, local processing, and modulation) and a carrier wave for uplink communication (e.g., the reflection of the downlink signal). For example, a portion of the downlink signal will be backscattered as an uplink signal and a remaining portion of the downlinks signal can be used to perform energy harvesting.

Active energy harvesting devices can transmit uplink communications without performing backscatter modulation and without receiving a corresponding downlink signal (e.g., an active energy harvesting device includes an energy storage element to provide electrical power and includes a powered transceiver to generate a carrier wave for an uplink communication). In the absence of a downlink signal, ambient energy harvesting devices (e.g., passive and semi-passive energy harvesting devices) may be unable to transmit an uplink signal (e.g., passive communication). Active energy harvesting devices do not depend on receiving a downlink signal in order to transmit an uplink signal and can transmit an uplink signal as desired (e.g., active communication).

In examples in which the energy harvesting device 500 is implemented as an ambient energy harvesting device (e.g., a passive or semi-passive energy harvesting device), a continuous carrier wave downlink signal may be received using antenna(s) 590 and modulated (e.g., re-modulated) for uplink communication. In some cases, a modulator 560 can be used to modulate the reflected (e.g., backscattered) portion of the downlink signal. For example, the continuous carrier wave may be a continuous sinusoidal wave (e.g., sine or cosine waveform) and modulator 560 can perform modulation based on varying one or more of the amplitude and the phase of the backscattered reflection. Based on modulating the backscattered reflection, modulator 560 can encode digital symbols (e.g., such as binary symbols or more complex systems of symbols) indicative of an uplink communication or data message. For example, the uplink communication may be indicative of sensor data or other information associated with the one or more sensors 570 included in energy harvesting device 500.

As mentioned previously, impedance matching component 510 can be used to match the impedance of antenna(s) 590 to the receive components of energy harvesting device 500 when receiving the downlink signal (e.g., when receiving the continuous carrier wave). During backscatter operation (e.g., when transmitting an uplink signal), modulation can be performed based on intentionally mismatching the antenna input impedance to cause a portion of the incident downlink signal to be scattered back. The phase and amplitude of the backscattered reflection may be determined based on the impedance loading on the antenna(s) 590. Based on varying the antenna impedance (e.g., varying the impedance mismatch between antenna(s) 590 and the remaining components of energy harvesting device 500), digital symbols and/or binary information can be encoded (e.g., modulated) onto the backscattered reflection. Varying the antenna impedance to modulate the phase and/or amplitude of the backscattered reflection can be performed using modulator 560.

As illustrated in FIG. 5, a portion of a downlink signal received using antenna(s) 590 can be provided to a demodulator 520, which performs demodulation and provides a downlink communication (e.g., carried or modulated on the downlink signal) to a micro-controller unit (MCU) 550 or other processor included in the energy harvesting device 500. A remaining portion of the downlink signal received using antenna(s) 590 can be provided to energy harvester 530, which harvests RF energy from the downlink signal. For example, energy harvester 530 can harvest RF energy based on performing AC-to-DC (alternating current-to-direct current) conversion, wherein an AC current is generated from the sinusoidal carrier wave of the downlink signal and the converted DC current is used to power the energy harvesting device 500. In some aspects, energy harvester 530 can include one or more rectifiers for performing AC-to-DC conversion. A rectifier can include one or more diodes or thin-film transistors (TFTs). In one illustrative example, energy harvester 530 can include one or more Schottky diode-based rectifiers. In some cases, energy harvester 530 can include one or more TFT-based rectifiers.

The output of the energy harvester 530 is a DC current generated from (e.g., harvested from) the portion of the downlink signal provided to the energy harvester 530. In some aspects, the DC current output of energy harvester 530 may vary with the input provided to the energy harvester 530. For example, an increase in the input current to energy harvester 530 can be associated with an increase in the output DC current generated by energy harvester 530. In some cases, MCU 550 may be associated with a narrow band of acceptable DC current values. Regulator 540 can be used to remove or otherwise decrease variation(s) in the DC current generated as output by energy harvester 530. For example, regulator 540 can remove or smooth spikes (e.g., increases) in the DC current output by energy harvester 530 (e.g., such that the DC current provided as input to MCU 550 by regulator 540 remains below a first threshold). In some cases, regulator 540 can remove or otherwise compensate for drops or decreases in the DC current output by energy harvester 530 (e.g., such that the DC current provided as input to MCU 550 by regulator 540 remains above a second threshold).

In some aspects, the harvested DC current (e.g., generated by energy harvester 530 and regulated upward or downward as needed by regulator 540) can be used to power MCU 550 and one or more additional components included in the energy harvesting device 500. For example, the harvested DC current can additionally be used to power one or more (or all) of the impedance matching component 510, demodulator 520, regulator 540, MCU 550, sensors 570, modulator 560, etc. For example, sensors 570 and modulator 560 can receive at least a portion of the harvested DC current that remains after MCU 550 (e.g., that is not consumed by MCU 550). In some cases, the harvested DC current output by regulator 540 can be provided to MCU 550, modulator 560, and sensors 570 in series, in parallel, or a combination thereof.

Sensors 570 can be used to obtain sensor data (e.g., such as sensor data associated with an environment in which the energy harvesting device 500 is located). Sensors 570 can include one or more sensors, which may be of a same or different type(s). In some aspects, one or more (or all) of the sensors 570 can be configured to obtain sensor data based on control information included in a downlink signal received using antenna(s) 590. For example, one or more of the sensors 570 can be configured based on a downlink communication obtained based on demodulating a received downlink signal using demodulator 520. In one illustrative example, sensor data can be transmitted based on using modulator 560 to modulate (e.g., vary one or more of amplitude and/or phase of) a backscatter reflection of the continuous carrier wave received at antenna(s) 590. Based on modulating the backscattered reflection, modulator 560 can encode digital symbols (e.g., such as binary symbols or more complex systems of symbols) indicative of an uplink communication or data message. Modulator 560 can generate an uplink, backscatter modulated signal based on receiving sensor data directly from sensors 570. Modulator 560 can generate an uplink, backscatter modulated signal based on received sensor data from MCU 550 (e.g., based on MCU 550 receiving sensor data directly from sensors 570).

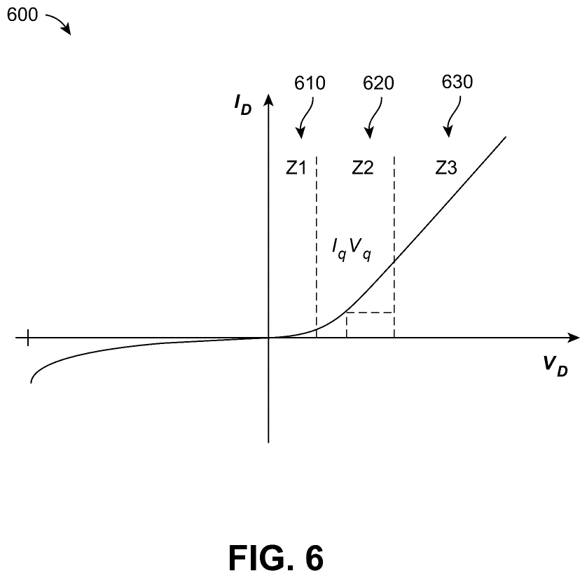

FIG. 6 is a diagram 600 illustrating an example of a small signal rectification operation that may be associated with performing energy harvesting. In one illustrative example, the small signal rectification operation may be a small signal rectification operation associated with a Schottky diode barrier (e.g., a Schottky diode used to perform rectification associated with energy harvester 530 illustrated in FIG. 5).

In some cases, the rectification process in a diode barrier (e.g., Schottky diode or other diode) associated with performing energy harvesting can be classified into small signal operation and large signal operation. For example, large signal operation is associated with rectifying an input signal (e.g., a received downlink signal at an energy harvesting device that includes the diode) having a relatively large amplitude signal that causes the diode to operate in its resistive zone. Small signal operation (e.g., such as the example small signal operation illustrated in FIG. 6) can be associated with rectifying an input signal (e.g., or portion thereof) having a relatively small amplitude signal, such that the diode does not operate in its resistive zone.

For example, small signal operation of a rectifying process in a Schottky diode barrier may be associated with three different operating zones, as depicted in FIG. 6. In a first operating zone 610, the diode behavior may be approximated as quadratic. For example, in the first operating zone 610, the output signal of the diode may be proportional to the square of the input signal to the diode. In some cases, the first operating zone 610 may also be referred to as a square law zone. In a second operating zone 620, the diode behavior may become more affected by other contributions, and the relationship between the output-input signal of the diode may decrease from quadratic towards linear. In some cases, the second operating zone 620 may also be referred to as a transition zone. In a third operating zone 630, the output signal of the diode may be proportional to the input signal to the diode (e.g., a linear relationship between input and output signals of the diode) and no DC component is generated. The third operating zone 630 may also be referred to as a resistive zone.

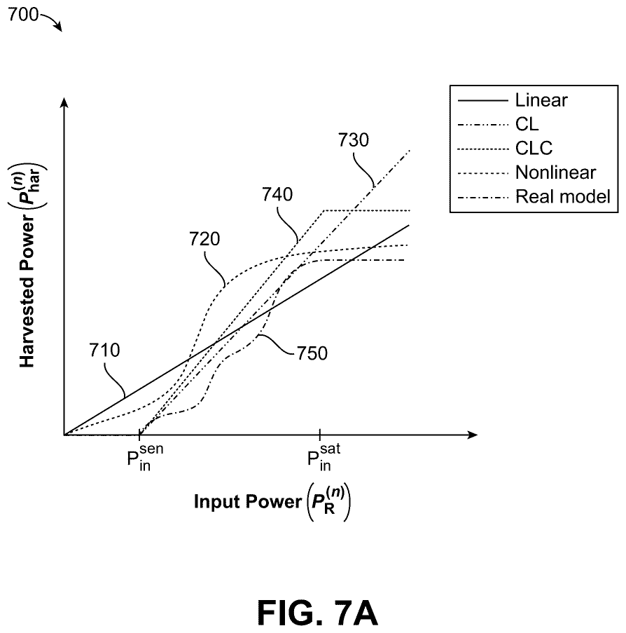

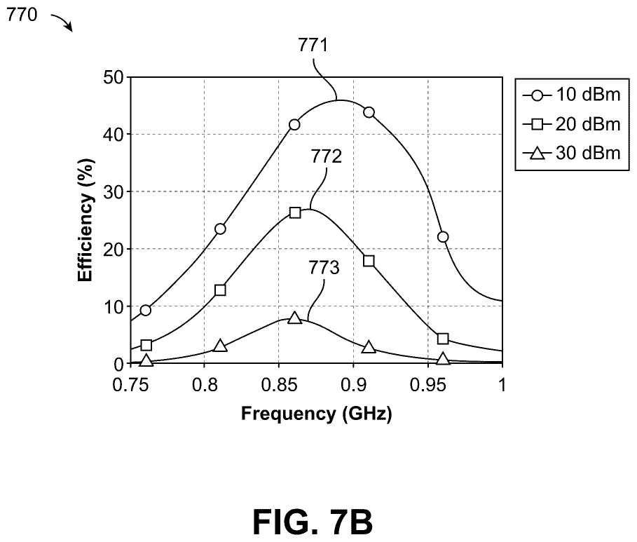

FIG. 7A is a diagram 700 illustrating examples of input power-harvested power conversion models that may be associated with various energy harvesting devices (e.g., such as the energy harvesting device 500 illustrated in the example of FIG. 5, above). Diagram 700 includes a first power conversion model 710, a second power conversion model 720, a third power conversion model 730, a fourth power conversion model 740, and a fifth power conversion model 750. In some aspects, different energy harvesting devices may be associated with different models between input power (e.g., the total RF energy or power of the portion of the received downlink signal provided to energy harvester 530 illustrated in FIG. 5) and harvested power (e.g., the RF energy or power that is harvested and output by energy harvester 530). In some aspects, the power conversion models 710-750 may be associated with ambient energy harvesting devices (e.g., passive and/or semi-passive energy harvesting devices) and/or active energy harvesting devices.

The first power conversion model 710 can be associated with a first type or category of energy harvesting devices. For example, energy harvesting devices having the first power conversion model 710 can provide harvested power as a continuous, linear, increasing function of the input RF power.

The second power conversion model 720 can be associated with a second type or category of energy harvesting devices. For example, energy harvesting devices having the second power conversion model 720 can provide harvested power as a continuous, non-linear, increasing function of the input RF power.

The third power conversion model 730 can be associated with a third type or category of energy harvesting device. For example, energy harvesting devices having the third power conversion model 730 can provide harvested power that is a continuous, linear, increasing function of the input RF power, given that the input RF power is above a sensitivity threshold

$$( {P}_{in}^{sen} ) .$$

The sensitivity threshold

$${P}_{in}^{sen}$$

can represent a minimum input RF power for which the energy harvesting device is able to perform harvesting (e.g., is able to harvest a non-zero amount of power). When the input RF power is below the sensitivity threshold

$$( {P}_{i n}^{s e n} ) ,$$

the harvested power is zero.

The fourth power conversion model 740 can be associated with a fourth type or category of energy harvesting device. For example, energy harvesting devices having the fourth power conversion model 740 can provide harvested power that is a continuous, linear, increasing function of the input RF power, given that the input RF power is both above the sensitivity threshold

$${P}_{i n}^{s e n}$$

and is below a saturation threshold

$${P}_{i n}^{sat} .$$

As illustrated, the saturation threshold

$${P}_{i n}^{sat}$$

is greater than the sensitivity threshold

$${P}_{i n}^{s e n} .$$

When the input RF power is below the sensitivity threshold

$${P}_{i n}^{s e n} ,$$

the harvested power is zero. When the input RF power is above the saturation threshold

$${P}_{i n}^{sat} ,$$

the harvested power output saturates (e.g., remains approximately constant for any input RF power above the saturation threshold).

The fifth power conversion model 750 can be associated with a fifth type or category of energy harvesting device. For example, for an input RF power between the sensitivity threshold

$${P}_{i n}^{s e n}$$

and the saturation threshold

$${P}_{i n}^{sat} ,$$

energy harvesting devices having the fifth power conversion model 750 can provide harvested power that is a continuous, non-linear, increasing function of the input RF power.

An efficiency of an energy harvesting device can be determined as a percentage of the input RF power that is converted into harvested power. FIG. 7B is a diagram 770 illustrating an example of energy conversion efficiency versus frequency (e.g., of an input waveform to the energy harvesting device) for different input powers. For example, a first efficiency-frequency relationship 771 is shown for an input RF power of −10 dBm (decibel milliwatts), a second efficiency-frequency relationship 772 is shown for an input RF power of −20 dBm, and a third efficiency-frequency relationship 773 is shown for an input RF power of −30 dBm.

The three efficiency-frequency relationships 771, 772, 773 depicted in FIG. 7B may each be associated with an optimum operating frequency, or an optimum operating frequency band, for which the energy conversion efficiency of a corresponding energy harvesting device is maximized. For example, for an input RF power of −30 dBm, an energy harvesting device with a power conversion model associated with the third efficiency-frequency relationship 773 may maximize its energy conversion efficiency with an input RF waveform centered at a frequency of 0.86 GHz. In another example, for an input RF power of −20 dBm, an energy harvesting device with a power conversion model associated with the second efficiency-frequency relationship 772 may maximize its energy conversion efficiency with an input RF waveform centered at a frequency of 0.87 GHz. In another example, for an input RF power of −10 dBm, an energy harvesting device with a power conversion model associated with the first efficiency-frequency relationship 771 may maximize its energy conversion efficiency with an input RF waveform centered at a frequency of 0.89 GHz.

The efficiency of an energy harvesting device may vary based on the input RF power (e.g., the RF power of the downlink signal received at an antenna of the energy harvesting device) and the center frequency of the input RF waveform. For example, as illustrated in FIG. 7B, the maximum or peak efficiency of an energy harvesting device that receives a relatively low input RF power may be less than the maximum or peak efficiency of an energy harvesting device that receives a relatively high input RF power (e.g., at −30 dBm the peak efficiency of the energy conversion model associated with the third efficiency-frequency relationship 773 is below 10%, at −20 dBm the peak efficiency of the energy conversion model associated with the second efficiency-frequency relationship 772 is approximately 25%, and at −10 dBm the peak efficiency of the energy conversion model associated with the first efficiency-frequency relationship 771 is approximately 45%). In some cases, conversion efficiency can decrease for frequencies that are greater than the optimum input center frequency and can decrease for frequencies that are less than the optimum input center frequency.

In some aspects, the conversion efficiency of an energy harvesting device may be associated with one or more energy conversion characteristics (e.g., also referred to as energy harvesting characteristics). For example, one or more characteristics may be indicative of a relationship between the conversion efficiency of an energy harvesting device and input frequency. In one illustrative example, an energy harvesting device may have an approximately constant conversion efficiency over a narrowband operating bandwidth (e.g., such as 20 MHz or less). In such examples, the energy harvesting device can receive RF energy from a multi-sine downlink wave with uniform power distribution. In another illustrative example, an energy harvesting device with a wideband operating bandwidth (e.g., such as 20 MHz or greater) may have a conversion efficiency that is a non-linear function of input frequency over the wideband. In such examples, the energy harvesting device may receive RF energy based on Gaussian and/or raised-cosine filters being used in combination with (e.g., on top of) the multi-sine downlink wave described above for narrowband operating bandwidths.

In some aspects, the energy conversion efficiency of an energy harvesting device may vary continuously with the input RF power. For example, the energy conversion efficiency may be zero for input powers less than the sensitivity threshold

$$( {P}_{i n}^{s e n} )$$

(e.g., based on the harvested power being equal to zero when the input RF power is below the sensitivity threshold, and conversion efficiency=harvested power/input RF power). The energy conversion efficiency of an energy harvesting device may vary over different input frequencies (e.g., as described above with respect to FIG. 7B) and may additionally vary over different input RF powers. For example, in some cases the energy conversion efficiency of an energy harvesting device may be approximately linear with input RF power, for input RF power values between the sensitivity threshold

$$( {P}_{i n}^{s e n} )$$

and a first input RF power value greater than

$${P}_{i n}^{s e n} .$$

The energy conversion efficiency may increase linearly with the input RF power from and above

$${P}_{i n}^{s e n} .$$

At input RF powers beyond the linear conversion efficiency zone, the energy conversion efficiency of the energy harvesting device may increase and/or decrease non-linearly with further increases in input RF power. The energy conversion efficiency may include one or more additional zones of linear increase (e.g., and/or linear decrease) with input RF power, in addition to an initial linear conversion efficiency zone beginning at the sensitivity threshold

$${P}_{i n}^{s e n} .$$

As discussed previously, certain aspects of the present disclosure relate to wireless communication systems and devices capable of concurrent Wireless Wide Area Network (WWAN) and Radio Frequency ID (RFID) communications. In a wireless communication network environment (e.g., cellular network, etc.), a network device or entity can be used to transmit downlink RF signals to energy harvesting devices. In some cases, the network device can be a UE (e.g., such as a non-energy harvesting UE), a repeater device, or repeater node, an Integrated Access and Backhaul (IAB) node, or other type of network device. In some cases, the network entity can be a base station (e.g., an eNB, a gNB, etc.) or other type of network entity. In some aspects, the network device or entity may also be referred to herein as an “energy source device,” an “energy transmitter device,” a “scheduler of energy transfer,” and/or an “energy transfer scheduler.” For example, a base station, gNB, UE, repeater device or node, and/or an IAB node may each be referred to as an energy source device, an energy transmitter device, a scheduler of energy transfer, and/or an energy transfer scheduler.

In some cases, the network device can be a base station, a gNB, a UE (e.g., such as a non-energy harvesting UE), a repeater device or repeater node, an Integrated Access and Backhaul (IAB) node, etc. In some aspects, the network device may also be referred to herein as an “energy source,” a “scheduler of energy transfer,” and/or an “energy transfer scheduler.” For example, a base station, gNB, UE, repeater device or node, and/or an IAB node may each be referred to as an energy source, a scheduler of energy transfer, and/or an energy transfer scheduler.

For example, a wireless device such as an energy source network device (e.g., base station, gNB, etc.) can read and/or write information stored on ambient energy harvesting IoT devices by transmitting a downlink RF signal. A downlink RF signal can provide energy to an ambient energy harvesting IoT device and can be used as the basis for an information-bearing uplink signal transmitted back to the energy source network device by the ambient energy harvesting IoT device (e.g., based on reflecting or backscattering a portion of the incident downlink RF signal). The energy source network device can read the reflected signal transmitted by an ambient energy harvesting IoT device to decode the information transmitted by the IoT device (e.g., such as sensor information collected by one or more sensors included in the IoT device, etc.).

In an example, disclosed systems include processors or chipsets that can configure one or more antennas to connect and/or communicate with one or more WWAN networks and energize RFID devices such as energy harvesting devices. As noted previously, as used herein, “configuring an antenna” or “reconfiguring an antenna” includes adjusting or tuning receive and/or transmit chains through which a baseband signal is translated from or to a signal compatible with the antenna, and/or includes programming additional functionality, such as impedance and/or antenna aperture tuners to align the antenna to a frequency band of interest. Such systems enable reuse of resources (e.g., processors, antennas, and/or RF systems), which can reduce cost and power consumption in wireless devices (e.g., mobile devices such as UEs). In this manner, antennas and/or compute resources may be dynamically reallocated from WWAN communications to RFID communications and/or from RFID communications to WWAN communications. For instance, an RFID system may emit continuous wave transmissions that energize RFID harvesting devices while simultaneously communicating on one or more WWANs. Such concurrency enables end user applications that use RFID while maintaining connectivity with cellular systems such as NR (5G), LTE, 3G, Global System for Mobile Communications (GSM), Code Division Multiple Access (CDMA), Wideband CDMA (WCDMA), first generation (1×) cellular networks, and so forth. RFID communications may involve emitting an inventory sequence, an example of which is provided in FIG. 8.

FIG. 8 is a diagram illustrating an example of a radio frequency identification (RFID) inventory sequence 800. FIG. 8 depicts time-division duplexing including alternating transmissions such as continuous wave (CW) transmissions, and reception of messages from an energy harvesting device such as a tag.

One or more RFID tags may be read in sequence. Sequence 800 includes example single tag read sequence 810 and multi-tag read sequence 860. As depicted, single tag read sequence 810 and multi-tag read sequence 860 include a sequence of various transmissions and receptions. Sequences 810 and 860 are exemplary; variations are possible.

The sequence 810 and the sequence 860 each include various continuous wave segments, during which a continuous wave is emitted via an antenna. The sequence 810 and the sequence 860 also each include various receive segments, during which the device listens for transmissions from the one or more RFID tags. The CW energizes any tags within range, or if the tags are already energized, maintains the tags energized before the tags are read.

Single tag read sequence 810 includes continuous wave (CW) 812, select 814, CW 816, query 818, CW 820 (and RN16 message 840), Acknowledgement (ACK) 822, and CW 824 (and EPC message 842). In the single tag read sequence 810, a reader device can use the sequence Query(T)→RN16(R)→ACK(T)→EPC(R) to read one tag, where “T” refers to the reader transmitting and “R” refers to the reader receiving (i.e., the tag transmitting). For instance, the reader device can first transmit a continuous wave (CW) 812. In the example depicted, the transmission time is 1.5 milliseconds (ms), but other durations are possible.

Continuing the example, the reader device then transmits a Select(T)/Challenge(T) message 814 to one or more tags. The reader device transmits a second CW 816 for a time T₄. In response, the tag emits the RN16 message 840, T₁ time after a start of CW 820, ending T₂ time before the end of CW 820. During this time, the reader continues to emit a CW 820. The reader responds with an ACK message 822. In response, the tag emits an EPC message 842 while the reader continues to emit CW 824. The EPC message is emitted T₁ time after the start of CW 824 but T₂ time before the end of the period corresponding to CW 824.

The RFID specification provides for a potentially short turnaround time for timers T₁ and T₂. This short turnaround time causes a need for substantial computational resources, in addition to at least one antenna for RFID application. In some cases, meeting additional requirements may be required. Such requirements may include FHSS spectrum signaling for UL in the USA and a need to meet Anti-Jammer requirements in the European Union (EU).

Multi sequence 860 includes the operations of single tag read sequence 810, followed by one or more repetitions of parts of sequence 810 such as Query rep 826, CW 828, ACK 830, CW 832, query rep 834, RN16 message 844, and EPC message 846. More specifically, multi-tag read sequence 860 includes messages QueryRep(T)→RN16(R)→ACK(T)→EPC(R) to read subsequent tags, which follows the initial message sequence, with a particular pre-defined timing cadence. These messages may be repeated, once for each additional tag.

A duration of the sequences depends on a particular configuration that the reader selects for transmit and receive data transmissions. In an example, a typical duration of the single tag read sequence 810 is from 1.2 to 50 ms. By contrast, the multi tag read sequence 860 may range as follows:

$$\{ 1.2 - 50 \} + ( a no\_of \_tags read ) * \{ 0.5 - 41 \} ms$$

In some cases, at least 1.5 ms may be needed to power up tags before sending any commands.

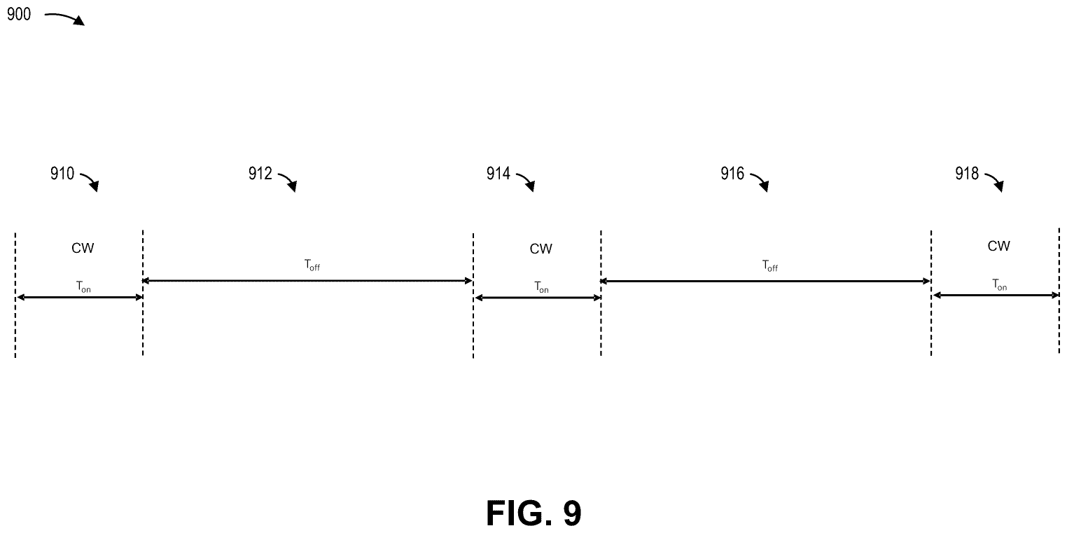

FIG. 9 is a diagram illustrating an example 900 of radio frequency identification (RFID) tones. Example 900 illustrates various miscellaneous aspects of RFID technology that may be relevant to certain aspects.

As depicted, the example 900 includes five time periods 910, 912, 914, 916, and 918. But other time periods are possible. In the example depicted, during time period 910, a continuous wave (CW) is emitted for Tₒₙ time. A tag may charge an embedded capacitor during time period 910, which can enable the tag to respond during subsequent time periods such as time period 912. As depicted, time period 912 has a period of length T_{off} time. During time period 914, a CW is emitted for Tₒₙ time. During time period 916, more tags may emit messages during T_{off} time. During time period 918, a CW is emitted for Tₒₙ time.

As discussed, certain aspects relate to improved wireless communication systems and devices capable of concurrent WWAN and RFID communications. As explained further below, disclosed systems may leverage periods of Discontinuous Reception (DRX) to enable RFID functionality. DRX is an energy saving technique that allows a user device to intermittently check for incoming downlink traffic.

The energy efficiency of wireless communication between client devices (e.g., UEs, etc.) and base stations (e.g., gNBs, etc.) can vary based on various factors. As used herein, the “energy efficiency” associated with wireless communications at a UE or base station may be referred to interchangeably as the “power consumption” associated with the wireless communications at the UE or base station.

Power consumption for wireless communications can include a power consumption associated with transmitting wireless signals and a power consumption associated with receiving wireless signals. For example, a UE power consumption can include the power consumption associated with the UE actively transmitting wireless signals (e.g., to a base station or gNB) and the power consumption associated with the UE actively receiving wireless signals (e.g., from a base station or gNB).

In addition to the power consumption associated with actively transmitting or receiving, a UE additionally consumes power while in an active or ‘On’ state where the UE is configured to be continuously ready to transmit or receive data. For instance, a UE consumes power while waiting to receive data from a base station or gNB, even when no data is being transmitted by the base station or gNB. The UE remains continuously awake in order to decode downlink data, as the data in the downlink may arrive at any time. The UE may monitor a physical downlink control channel (PDCCH) in every subframe to check whether a PDCCH is available scheduling or otherwise indicating downlink data for the UE. Continuously monitoring PDCCH for possible downlink (DL) and/or uplink (UL) data, the UE may consume a large portion of the available power at the UE (e.g., a large portion of the available battery power at the UE).

In some cases, power saving techniques can be implemented for client devices, for base stations, and/or for a combination of the two. Some power saving techniques are based on managing the energy efficiency or energy consumption of various periodic communications between UEs and base stations. For example, discontinuous reception (DRX) can be used to configure PDCCH periodic monitoring, where a UE wakes up to monitor for downlink data during a periodic DRX-enabled state and enters a low-power sleep or idle mode outside of the periodic DRX-enabled state (e.g., during a DRX-disabled state). Discontinuous transmission (DTX) can be used to configure periodic transmission of uplink signals by a UE (e.g., during a periodic DTX-enabled state), where the UE enters the low-power sleep or idle mode outside of the periodic DTX-enabled state (e.g., during a DTX-disabled state).

In some cases, DRX implemented by a UE can also be referred to as connected mode DRX. The connected mode DRX can be used to improve UE battery power consumption based on the UE periodically entering a ‘sleep’ state for an ‘off-duration’ during which the UE does not monitor PDCCH. To monitor PDCCH for possible downlink/uplink data, the UE can be configured to wake up periodically and remain in an ‘awake’ state for an ‘on-duration.’ DRX implemented by a UE can also be referred to as “UE-DRX.”

DRX implemented by a UE can include various types of DRX. For instance, one type of UE-DRX is Inactivity-based DRX (e.g., I-DRX). A UE implementing I-DRX may enter a low-power state when the UE is not actively engaged in data transmission or reception. For instance, an inactivity period can be defined or configured for I-DRX by the network. In I-DRX mode, a UE discontinuously receives data by periodically waking up to listen for a paging signal or other control information from the network. If there is nothing to receive (e.g., as indicated by a paging signal or other control information), the UE can return to the low-power state until the next scheduled wake-up time.

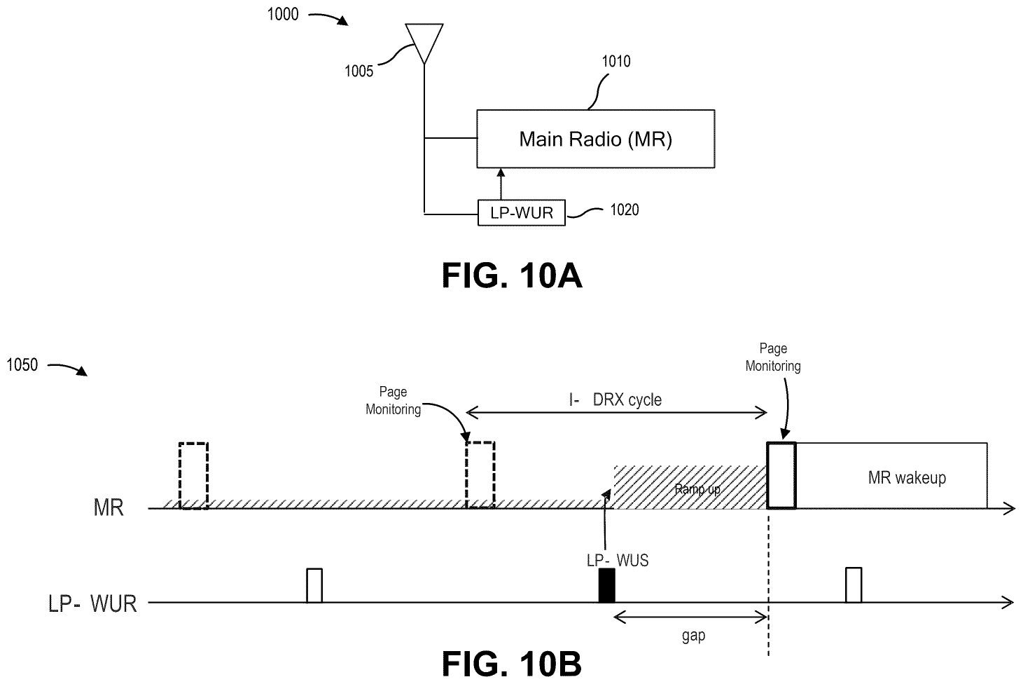

FIGS. 10A and 10B illustrate a communication system 1000 that may implement DRX. FIG. 10A is a diagram illustrating an example of a communication system 1000 (e.g., wireless communication device, such as a UE) including a main radio (MR) and a low-power wake-up receiver (LP-WUR) associated with the MR. In addition to latency, reliability, and availability, UE energy efficiency is an important factor for the design of wireless communication systems and standards, including 5G NR and beyond. Energy efficiency can be an important consideration for UEs without a continuous energy source device (e.g., UEs using small rechargeable batteries, single coin cell batteries, etc.). Some UEs may be implemented as IoT UEs, such as connected sensors or actuators, and may be deployed with non-rechargeable batteries and used for purposes such as monitoring, measuring, etc. Wearables devices can include wearable UEs, such as smart watches, rings, health-related devices, medical monitoring devices, etc., and may struggle to sustain a battery life of one to two weeks as is required.

The communication system 1000 (a wireless communication device such as a UE) can include a low-power wake-up receiver (LP-WUR) 1020 and a main radio (MR) 1010. The LP-WUR 1020 can be a companion receiver of the MR 1010, and may be implemented in parallel with the MR 1010. For instance, the LP-WUR 1020 and the MR 1010 may share antenna 1005 of the communication system 1000. The power consumption of a UE can be based on the configured length of wake-up periods (e.g., paging cycle). Currently, UEs may need to periodically wake up once per discontinuous reception (DRX) cycle, an action which can dominate the UE power consumption in periods with no signaling or data traffic to the UE. The LP-WUR 1020 can be used to cause the UE to wake up only when the UE is triggered to do so by the network or a network entity. Using the LP-WUR 1020 to wake the communication system 1000 (e.g., using the LP-WUR 1020 to wake the MR 1010 of the communication system 1000) can reduce paging and power consumption of the communication system 1000. For instance, a wake-up signal (WUS) can be used to cause the MR 1010 to wake up and/or exit a deep sleep state. The LP-WUR 1020 is a separate receiver from the MR 1010 and can be configured with the ability to monitor for a WUS or other low-power signal, using a lesser power consumption than the MR 1010.

In some case, the LP-WUR 1020 may be configured to perform continuous monitoring for a LP-WUS. The LP-WUR 1020 can be configured to perform discontinuous monitoring for a LP-WUS, for instance with T milliseconds (ms) as the period to complete an on-and-off discontinuous LP-WUS monitoring cycle by the LP-WUR 1020, and D ms as the active time for monitoring LP-WUS every cycle.

FIG. 10B is a diagram illustrating an example of wireless communications 1050 performed using the MR 1010 and LP-WUR 1020 of FIG. 10A. A communications timeline is shown corresponding to the MR 1010 of FIG. 10A in the upper portion of FIG. 10B, and a communications timeline is shown corresponding to the LP-WUR 1020 of FIG. 10A in the lower portion of FIG. 10B. The MR can be associated with a plurality of page monitoring occasions, which corresponding to a configured length of wake-up periods for receiving and/or transmitting control information and/or data by the MR of the UE. In some cases, a page monitoring occasion can correspond to a wake-up period or paging cycle of the UE and the MR. For instance, each page monitoring occasion can correspond to an I-DRX cycle.

The LP-WUR can be implemented as a companion receiver of the MR and can be configured to process low-power wake-up signals (LP-WUSs) transmitted by a network entity (e.g., base station, gNB, etc.). In some cases, the LP-WUR can additionally process one or more control signals from the network entity. The use of the LP-WUR can allow the MR to skip one or more page monitoring occasions, and remain in a deep sleep state (e.g., an ultra-deep sleep state) during the one or more skipped page monitoring occasions. During a page monitoring occasion skipped by the MR, the LP-WUR can monitor for a LP-WUS on a LP-WUS monitoring occasion that corresponds to at least one of the skipped page monitoring occasions of the MR. For example, the LP-WUR can monitor for a LP-WUS on a LP-WUS monitoring occasion that is between the first and second skipped page monitoring occasions of the MR, as shown in the timelines of FIG. 10B.

Based on not receiving a LP-WUS during the LP-WUS monitoring occasion, the LP-WUR may take no action, and can allow the MR to remain in ultra-deep sleep state. In the second LP-WUS monitoring occasion shown in FIG. 10B for the LP-WUR timeline, the LP-WUR receives an LP-WUS from the network entity (e.g., gNB, base station, etc.). The network entity may transmit the LP-WUS to be indicative of traffic arriving at the gNB for the UE (e.g., traffic arriving at the gNB needing the MR of the UE for receiving). Based on receiving the LP-WUS in the second LP-WUS monitoring occasion, the LP-WUR can trigger the MR to exit the deep sleep state. For instance, the LP-WUR can transmit a wake-up signal (WUS) to the MR, based on the LP-WUR receiving the LP-WUS from the network entity.

The MR can begin exiting the deep sleep state and transitioning to an active (e.g., on or awake) state, with a corresponding transition or ramp up time between the MR receiving the trigger to exit the deep sleep state and the MR reaching the awake state where the MR is ready to receive data traffic from the network entity. For instance, the ramp up period of the MR wakeup can be associated with a time delay or time gap relative to the receipt of the LP-WUS at the LP-WUR, as shown in FIG. 10B. In some cases, the LP-WUS can be configured with transmission timing such that the LP-WUR triggers the MR to wake up sufficiently early relative to the next page monitoring occasion (e.g., next I-DRX cycle). Based on completing the ramp up and entering the awake state by the beginning of the next page monitoring occasion for the next I-DRX cycle, the MR of the UE is able to receive the transmitted data from the network entity at high speed during the MR wakeup period corresponding to the received LP-WUS.

As noted previously, systems and techniques described herein facilitate concurrent communication of WWAN and RFID signals. The systems and techniques can permit a more granular control between RFID and WWAN stacks. A stack, or a subscription, may refer to a set of architectural layers that describe network transactions and communications between devices, implemented in software and/or hardware. Such coordination assists in lowering power consumption relative to existing solutions, which may employ multiple parallel sets of resources such as antennas, RF, baseband resources, and so forth. Disclosed solutions enable a lowering a number of parts on a bill of materials associated with a system.

The systems and techniques can provide improvements relative to existing solutions. In one illustrative example, a mobile device can be in a WWAN Radio Access Technology (RAT) active state and may need to initiate an RFID transaction. In some cases, the mobile device's WWAN resources may be shared with the RFID system, including continuous wave emission to an RFID device (e.g., to energize an ambient energy harvesting IoT device) and reception of communications from the RFID device (e.g., backscatter signals from the ambient energy harvesting IoT device). In a resource constrained environment (e.g., with limited antennas and/or compute resources), resources may be reallocated. For example, a single antenna may be reused between WWAN and RFID. Compute resources may also be shared, for instance, processing RFID transactions when the WWAN stack is inactive.

Some aspects facilitate concurrent communication of WWAN and RFID signals. Disclosed solutions permit a more granular control between RFID and WWAN stacks. This coordination assists in lowering power consumption relative to existing solutions, which may employ multiple parallel sets of resources such as antennas, RF, baseband resources, and so forth.

In one example, a mobile device is in a WWAN RAT active state and may need to initiate an RFID transaction. In some cases, the mobile device's WWAN resources may be shared with the RFID system, including continuous wave emission and reception. In a resource constrained environment (e.g., antennas and/or compute resources), resources may be reallocated. For example, a single antenna may be reused between WWAN and RFID. Compute resources may also be shared, for instance, processing RFID transactions when the WWAN stack is inactive. In some cases, disclosed systems may leverage periods of Discontinuous reception (DRX) such as Extended DRX (eDRX) or those discussed in Reduced Capability (RedCap) and/or Connected Mode DRX (CDRX) for RFID functionality.

As discussed, certain aspects involve reallocation of resources to facilitate RFID communications in single SIM and dual SIM systems. In some case, one or more antennas of a multi-antenna system may be reallocated from WWAN to RFID and vice versa. In some cases, an entire WWAN stack may be disabled to facilitate RFID communications. In some cases, a WWAN stack may be kept active while one or more strategies are employed such as forcing a mobile device to be out of service on a particular WWAN, thus releasing resources for RFID. In some cases, a mobile device may maintain an active session by switching to an idle state. In some cases, a number of WWAN layers and/or carriers may be reduced to facilitate RFID communications. In some cases, one or more modes, such as 5G Frequency (FR) modes (e.g., FR1 or FR 2) may be disabled to facilitate RFID communications. In this case, the WWAN continues communicating with the remaining 5G mode using UE Assistance Information (UAI) sent to the mobile device.

During operation of a method for wireless communications, one or more processors can determine, based on constraints on resources of the device (e.g., UE), a schedule for RFID operations (e.g., RFID communications) and WWAN operations (e.g., WWAN communications) on the device, where the resources can include compute resources and RF component resources (e.g., antennas, transceivers, filters, amplifiers, etc.). For example, the schedule can include specific time slots scheduled for transmitting and/or receiving WWAN data and/or for transmitting and/or receiving RFID data. The scheduling can be performed as discussed, for example, with respect to FIGS. 1-3. The one or more processors can then perform, based on the schedule, the RFID operations and the WWAN operations on the apparatus.

The processor can determine the schedule based on whether the device comprises a single subscriber identity module (SSIM) or multiple subscriber identity modules (MSIM). When the device includes the MSIM, the WWAN operations can include first WWAN operations and second WWAN operations. Based on the resources being constrained, the schedule can indicate performance of the WWAN operations using wireless communications, such as new radio (NR) (or 5G) communications, long-term evolution (LTE) (or 4G) communications, 6G communications, or other type of communications based technology. Based on the resources being constrained, the schedule can indicate performance of the WWAN operations using frequency range one (FR1) or frequency range two (FR2) (e.g., of NR communications or other communications, such as 6G communications). Based on the resources being constrained, the schedule can indicate performance of the WWAN operations using a reduced number of carriers from a total number of carriers available for WWAN communications. The schedule can indicate performance of the RFID operations during one or more sleep durations (e.g., sleep in idle states, sleep in connected states, such as sleep durations during connected mode discontinuous reception (CDRX), etc.) for the WWAN operations. The schedule can indicate performance of the RFID operations during one or more paging intervals for the WWAN operations.

The processor can be further configured to determine the schedule based on performance of the RFID operations having priority over performance of the WWAN operations. In some cases, WWAN operations may have priority over RFID operations, in which case RFID operations may be suspended so that WWAN operations can be performed. The RFID operations can include RFID receive operations and RFID transmit operations, and the WWAN operations can include WWAN receive operations or WWAN transmit operations. The schedule can indicate time division multiplexing (TDM) of the RFID operations and the WWAN operations. The schedule can indicate at least some simultaneous performance of the RFID operations and the WWAN operations. As described herein, the RF component resources can include one or more antennas, one or more filters, one or more amplifiers (e.g., low noise amplifiers (LNAs), one or more transceivers, one or more switches, among other RF component resources. The compute resources can include modem baseband resources. The apparatus can be user equipment (UE), such as a mobile device, for example a smartphone.

As discussed, certain aspects relate to wireless communication systems and devices capable of concurrent Wireless Wide Area Network (WWAN) and Radio Frequency ID (RFID) communications. In a wireless communication network environment (e.g., cellular network, etc.), a network device (e.g., such as a base station or gNB, etc.) can be used to transmit downlink RF signals to energy harvesting devices.

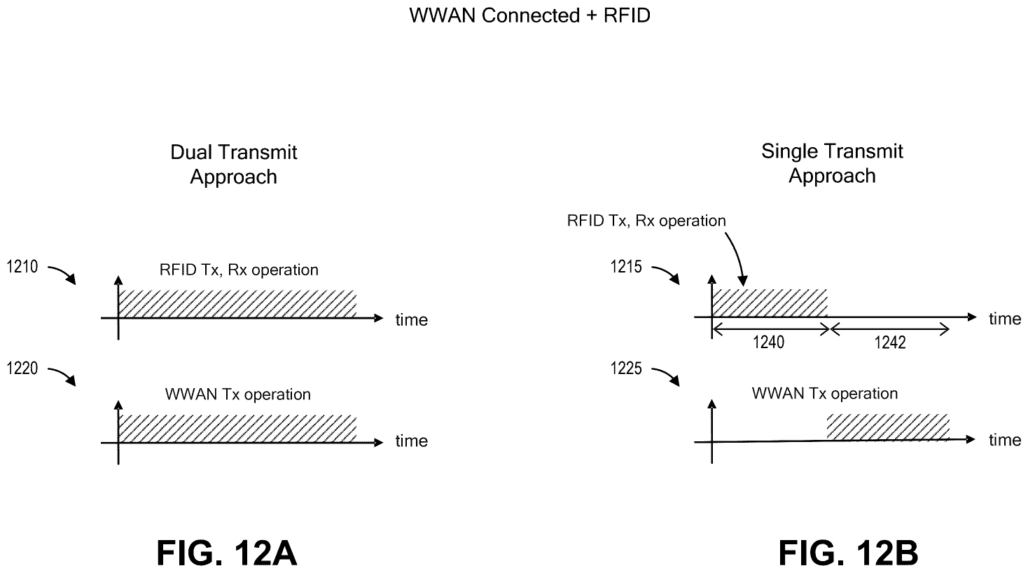

Some aspects relate to systems that communicate on a single WWAN using a single Subscriber Identity Module (SIM) concurrently with RFID communications. FIGS. 11A and 11B illustrate examples of scenarios applicable to WWAN idle mode, whereas FIGS. 12A and 12B illustrate examples of scenarios applicable to WWAN connected mode.

FIGS. 11A and 11B are diagrams illustrating examples of combined WWAN and RFID communication. The examples represent implementations of WWAN and RFID in a single-subscriber identity module (SIM) configuration in a WWAN idle mode. Each of FIGS. 11A and 11B depicts RFID stack 1110, 1115 and WWAN stack 1120, 1125. The RFID stack 1110, 1115 and WWAN stack 1120, 1125 may be implemented by the user device computing system 470. For instance, the user device computing system 470 may concurrently execute both an RFID stack and WWAN stack.

In particular, FIG. 11A depicts fully concurrent WWAN and RFID operations. Two antennas are available, therefore, RFID processing can continue during WWAN demodulation. As depicted, RFID transmit and/or receive operations may take place concurrently with WWAN receive operations. The WWAN receive operations may be required as part of a WWAN idle state.

By contrast, in some cases, applicable to a subset of RFID configurations, a constraint in resources may require a time-shared approach (e.g., a time-division multiplexing (TDM) approach) to sustain WWAN and RFID services. This approach can be an optimization option for low tier chipsets (e.g., platforms with a lower computational complexity). This approach is depicted in FIG. 11B. As can be seen, RFID receive operations can occur in a first time period 1140, whereas WWAN operations can occur in a second time period 1142. This approach can be used in an antenna and/or compute-constrained environment. In some applications, this approach can result in an acceptable trade-off between RFID and WWAN performance.

In an additional aspect, RFID operations can be scheduled (e.g., scheduled during one or more time slots) during a WWAN paging interval when the user equipment (UE) is in a session and in an idle state (e.g., during Idle mode DRX sleep). In some cases, RFID operations may be performed during a WWAN extended DRX (EDRX) sleep state.

FIGS. 12A and 12B are diagrams illustrating examples of combined WWAN and RFID communication. The examples represent implementations of WWAN and RFID in a single-subscriber identity module (SIM) configuration in a WWAN connected mode. Each of FIGS. 12A and 12B depicts RFID stack 1210, 1215 and WWAN stack 1220, 1225. The RFID stack 1210, 1215 and WWAN stack 1220, 1225 may be implemented by the user device computing system 470. For instance, the user device computing system 470 may concurrently execute both an RFID stack and WWAN stack.

The example depicted in FIG. 12A depicts fully concurrent WWAN and RFID operations. In the example depicted in FIG. 12A, RFID transmit and/or receive operations may occur concurrently with WWAN transmit operations. Two antennas are available, in which case the RFID processing can continue during WWAN demodulation. WWAN is active and, therefore, is able to transmit data while RFID communications occurs.

In some aspects, a Channel Quality Indicator (CQI)/Rank Indicator (RI)/Precoding Matrix Indicator (PMI) report can be sent to a base station (e.g., gNB) to reduce a number of layers used and number of antennas used, such as from four to two to one antennas (e.g., 4/2/1 antennas). Also, in some cases, this report may also trigger appropriate LTE/NR/6G/etc. Antenna Switched Diversity (ASDIV)/Antenna Reconfiguration for Diversity (ARD) protocols to initiate the change. This allows resources to be reallocated to RFID operations.

By contrast, the example depicted in FIG. 12B depicts time-multiplexed WWAN and RFID operations (e.g., TDM WWAN and RFID operations). Here, there may be a resource constraint associated with a user device, such as fewer number of antennas (and/or other RF component resources) or lower compute resources. RFID processing and WWAN demodulation are time shared, where the RFID operations (e.g., transmission and/or reception of RFID signals) are performed during time slot 1240 and WWAN operations (e.g., transmission and/or reception of WWAN signals) are performed during time slot 1242. This approach can have an acceptable degradation in performance for a subset of RFID configurations, which may require fewer compute resources. This approach can be an optimization option for low tier chipsets (e.g., platforms with a lower computational complexity). In some cases, a presence of interference may trigger the use of this configuration. In some cases, a number of RFID communications may occur when the WWAN is in a CDRX sleep state. In some cases, for CDRX sleep state, a single tag read sequence or a short length multi-tag read sequence may be performed (e.g., depending upon the duration of the sleep state).

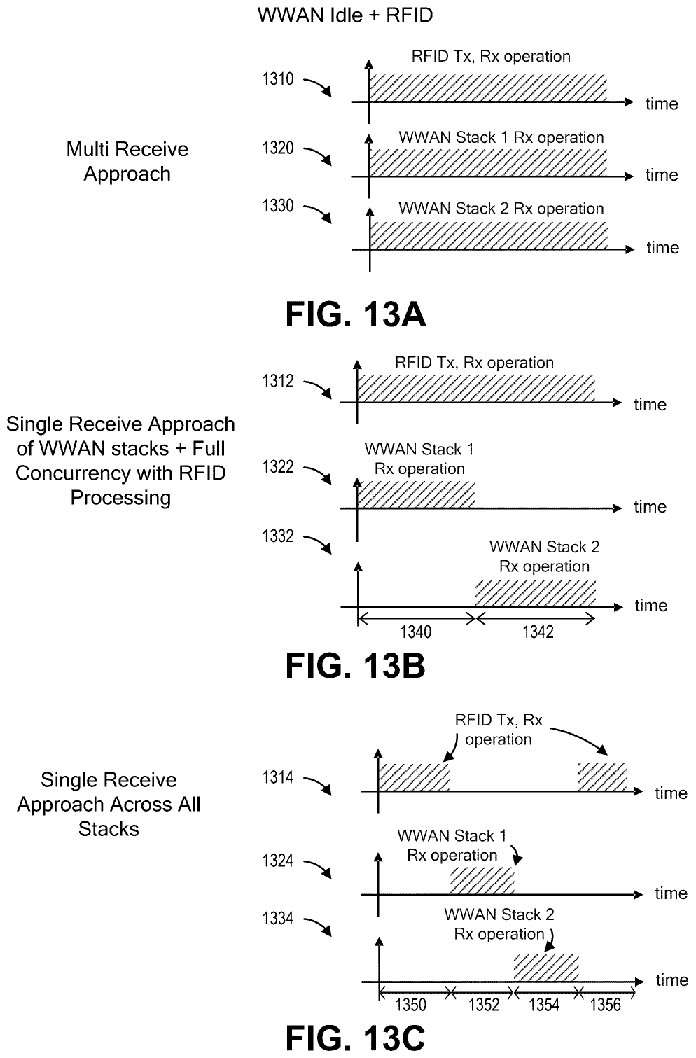

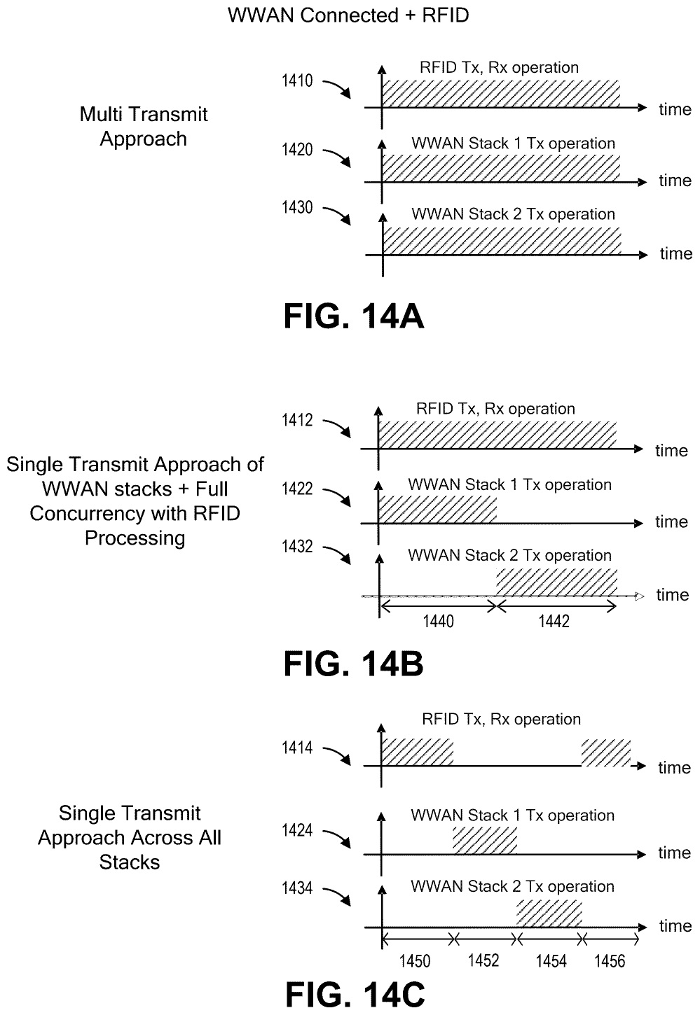

Some aspects relate to systems that communicate on two WWANs using multiple Subscriber Identity Modules (MSIMs) concurrently with RFID communications. Connections may be made to one or more cellular networks simultaneously. FIGS. 13A, 13B, and 13C illustrate examples of scenarios applicable to a WWAN idle mode, whereas FIGS. 14A, 14B, and 14C illustrate example scenarios applicable to a WWAN connected mode.

FIGS. 13A, 13B, and 13C are diagrams illustrating examples of combined WWAN and RFID communications. The examples represent implementations of WWAN and RFID, specifically, maintaining RFID communications while facilitating data communications on one or more WWANs in a multi-subscriber identity module (MSIM) configuration in a WWAN idle mode.

More specifically, the example depicted in FIG. 13A depicts WWAN communications occurring on two WWAN stacks concurrently with RFID communications. The WWAN communications may each be associated with a respective subscriber identity. For example, each of the WWAN communications may be communicating on a respective different cellular network. As depicted in FIG. 13A, communications on RFID stack 1310 operate concurrently with WWAN receive communications on a first WWAN stack 1320 and WWAN receive communications on a second WWAN stack 1330.

By contrast, in the example depicted in FIG. 13B, time multiplexing is involved. Communications on RFID stack 1312 may occur during both time periods 1340 and 1342, whereas receive communications on the first WWAN stack 1322 can operate in period 1340 followed by receive communications on the second WWAN stack 1332 in period 1342. In this case, WWAN communications are shared on a time-multiplexed (e.g., TDM) basis, while RFID communications can take place at any time.

In a third example depicted in FIG. 13C, only one stack may be active at once (e.g., at a time). More specifically, RFID communications on stack 1314 may operate at time slots 1350 and 1356, whereas receive communications on the first WWAN stack 1324 can operate in time period 1352 and receive communications on the second WWAN stack 1334 operate in time period 1354.

In a subset of RFID configurations, the compute resources constraint may lead to disabling the WWAN to allow RFID processing. In this case, a time-shared approach can be used. In some cases, this can occur in a low-end chipset, for example, due to low available computational resources.

In another aspect, RFID operations can be scheduled (e.g., scheduled during one or more time slots) during a WWAN paging interval when the user equipment (UE) is in a session and in an idle state (e.g., during Idle mode DRX sleep). In some cases, RFID operations may be performed during a WWAN extended DRX (EDRX) sleep state.

FIGS. 14A, 14B, and 14C are diagrams illustrating examples of combined WWAN and RFID communications. The examples represent implementations of WWAN and RFID, specifically, maintaining RFID communications while facilitating data communications on one or more WWANs in a multi-subscriber identity module (MSIM) configuration in a WWAN connected mode.

More specifically, the example depicted in FIG. 14A depicts WWAN communications occurring on two stacks concurrently with RFID communications. The WWAN communications may each be associated with a respective subscriber identity. For example, each of the WWAN communications may be communicating on a respective different cellular network.

For example, as depicted in FIG. 14A, communications on RFID stack 1410 may operate concurrently with transmit communications on a first WWAN stack 1420 and transmit communications on second WWAN stack 1430. Here, the first and second WWAN stacks can operate while the RFID stack performs transmit and/or receive operations. This approach can occur when more RF component resources (e.g., antennas, transceivers, etc.) and/or compute resources are available (e.g., a sufficient number of RF component and/or compute resources to perform WWAN and RFID transmit and/or receive operations).

In some aspects, a CQI/RI/PMI report sent to a base station (e.g., gNB) to reduce a number of layers used and the number of RF component resources used (e.g., from four to two to one antennas, transceivers, etc.). Also, in some cases, this report may also trigger appropriate protocols (e.g., LTE/NR/6G/etc. ASDIV/ARD protocols) to initiate the change. This allows resources to be reallocated to RFID operations.

By contrast, in the example depicted in FIG. 14B, communications on the RFID stack 1412 operate during both time periods 1440 and 1442, whereas transmit communications on the first WWAN stack 1422 operate in period 1440 followed by transmit communications on the second WWAN stack 1432 in period 1442. Here, the WWAN stacks multiplex transmit operations, but are fully concurrent with RFID operations.

In a certain subset of RFID configurations, the compute resources constraint may lead to disabling one or more WWANs to allow for RFID processing. For example, this can occur on platforms with lower computational complexity.

In a third example depicted in FIG. 14C, only one stack may be active at once. For instance, RFID communications on stack 1414 may operate at time slots 1450 and 1456, whereas transmit communications on the first WWAN stack 1424 operate in time period 1452 and transmit communications on the second WWAN stack 1434 operate in time period 1454. This time-shared approach may be employed in configurations with low available compute resources.

In some cases, a number of RFID communications can occur when the WWAN is in a CDRX sleep state. In some cases, one WWAN stack may be disabled to release antenna and/or compute resources for RFID communications purposes.

In some cases, one SIM stack can be deactivated if resource constraints exist in a MSIM configuration scenario. A preferred SIM to drop can be configured by user. In such cases, only one SIM may be used according to a schedule for RFID and WWAN operations (e.g., a schedule indicating time slots for transmitting and/or receiving RFID data and time slots for transmitting and/or receiving WWAN data).

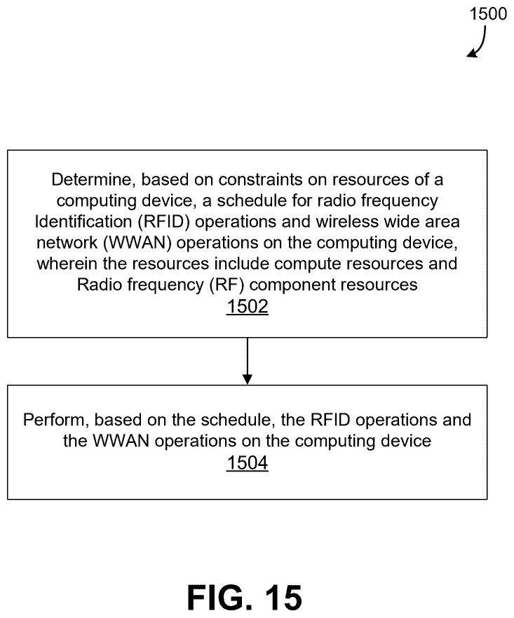

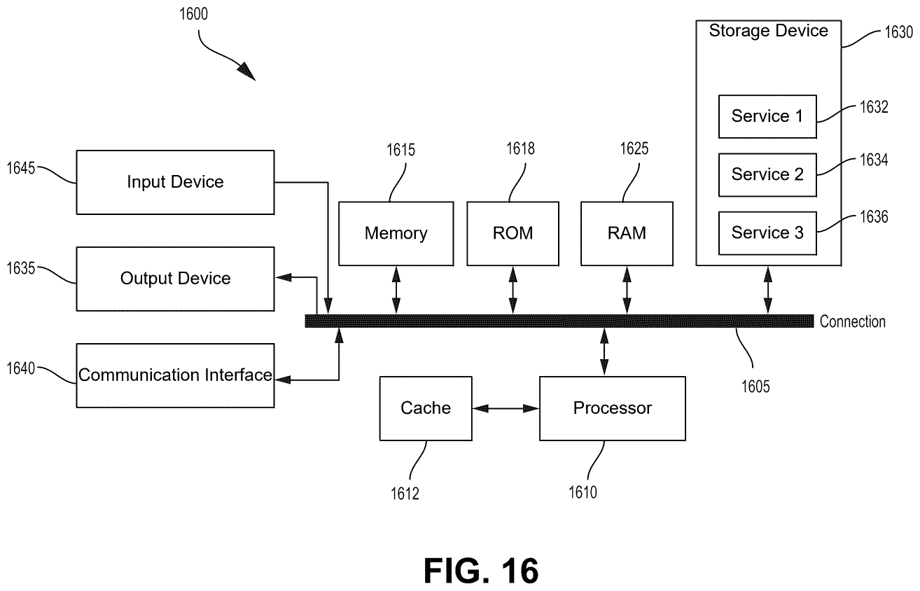

FIG. 15 is a flow chart illustrating an example of a process 1500 for wireless communications. The process 1500 can be performed by a computing device (e.g., a UE, the wireless device 407 of FIG. 4, etc.) or by a component or system (e.g., the computing system 1600 of FIG. 16, a chipset, one or more processors, central processing units (CPUs), digital signal processors (DSPs), graphics processing units (GPUs), any combination thereof, and/or other type of processor(s), any combination thereof, or other component or system) of the computing device. The operations of the process 1500 may be implemented as software components that are executed and run on one or more processors (e.g., processor 1610 of FIG. 16, or other processor(s)). Further, the transmission and reception of signals by the computing device in the process 1500 may be enabled, for example, by one or more antennas and/or one or more transceivers (e.g., wireless transceiver(s)).

At block 1502, the computing device (or component thereof) can determine, based on constraints on resources of the computing device, a schedule for radio frequency identification (RFID) operations and wireless wide area network (WWAN) operations on the computing device. The resources include compute resources and/or radio frequency (RF) component resources. In some aspects, the RF component resources include at least one of an antenna, a filter, an amplifier, a transceiver, or a switch. In some aspects, the compute resources include modem baseband resources.

In some aspects, the computing device (or component thereof) can determine the schedule based on whether the computing device includes a single subscriber identity module (SSIM) or multiple subscriber identity modules (MSIM). For instance, the computing device can include the MSIM. In some cases, the WWAN operations can include first WWAN operations and second WWAN operations. In such cases, the schedule can indicate simultaneous performance of at least some of the RFID operations, the first WWAN operations and the second WWAN operations.

In some aspects, based on the resources being constrained, the schedule indicates performance of the WWAN operations using new radio (NR) communications or long-term evolution (LTE) communications. For instance, based on the resources being constrained, the schedule can indicate performance of the WWAN operations using frequency range one (FR1) or frequency range two (FR2) of NR communications. In some cases, based on the resources being constrained, the schedule indicates performance of the WWAN operations using a reduced number of carriers (e.g., frequency carriers) from a total number of carriers available for WWAN communications.

In some aspects, the schedule indicates performance of the RFID operations during one or more sleep durations for the WWAN operations. In some cases, the schedule indicates performance of the RFID operations during one or more paging intervals for the WWAN operations.

The schedule may be determinative, for example for a certain number of communications or slots, or for a particular time period or session(s) or call(s), or while a certain constraint or set of constraints on the resource(s) exist or are applicable. The schedule may be prescriptive, for example such that a set of rules or preferences are used to determine behavior of the computing device further depending on future interactions, such as with a network entity or device (e.g., a base station or a portion of a base station, such as a CU, DU, RU, etc. of a disaggregated base station) and/or a RFID device (e.g., a tag or energy harvesting device). The schedule and/or behavior may be determined a priori and/or actively during communication with another device, may be modified based on the communication or conditions or the constraints, and/or may be determined using one or more AI/ML models.

At block 1504, the computing device (or component thereof) can perform, based on the schedule, the RFID operations and the WWAN operations on the computing device. In some cases, the computing device can transmit a message or report to a network entity or device (e.g., a base station or a portion of a base station, such as a CU, DU, RU, etc. of a disaggregated base station) to reduce a number of layers used and a number of antennas used by WWAN operations and/or used by RFID operations based on the constraints on the resources.

In some aspects, the computing device (or component thereof) can determine the schedule based on performance of the RFID operations having priority over performance of the WWAN operations. In some aspects, the computing device (or component thereof) can determine the schedule based on performance of the WWAN operations having priority over performance of the RFID operations. Such priority can be specified by a user, by a particular use case (e.g., whether the device is primarily being used for WWAN communications, such as a phone call, or RFID operations, such as inventorying a group of RFID tags, for example as described with respect to the RFID inventory sequency 800 of FIG. 8).

In some aspects, the RFID operations include RFID receive operations and RFID transmit operations, where the WWAN operations include WWAN receive operations and/or WWAN transmit operations.

In some aspects, the schedule indicates time division multiplexing (TDM) of the RFID operations and the WWAN operations based on at least the RF component resources being constrained. In some cases, the TDM includes scheduling the RFID operations and the WWAN operations in different time slots (e.g., the schedule indicating different time slots for transmitting RFID and WWAN resources). In some aspects, the computing device includes multiple subscriber identity modules (SIMs). Each SIM of the multiple SIMs include a corresponding operation stack. In such aspects, the TDM includes scheduling RFID operations and operations of each operation stack in different timeslots.

In some aspects, a computing device (or component thereof) (e.g., the wireless device 407 of FIG. 4, the computing device configured to perform the operations of the process 1500 of FIG. 15, the computing system 1600 of FIG. 16, etc.) can configure a first antenna to communicate WWAN signals. In some cases, the computing device (or component thereof) can establish a WWAN session with a network entity (e.g., a base station, such as an eNB, gNB, etc., or a portion of the base station such as a CU, a DU, a RU, a Near-RT RIC, or a Non-RT RIC of a disaggregated base station). The computing device (or component thereof) can configure a second antenna to receive RFID signals. In some cases, the computing device (or component thereof) can communicate, using the first antenna, a WWAN signal with the network entity and communicate, using the second antenna, a RFID signal. In some examples, to communicate the WWAN signal, the first antenna is configured to receive the WWAN signal from the network entity and, to communicate the RFID signal, the second antenna is configured to transmit the RFID signal to an energy harvesting device. The computing device (or component thereof) can configure a third antenna to communicate WWAN signals, establish a second WWAN session with a second network entity, communicate, using the third antenna, a second WWAN signal from the second network entity, and process the second WWAN signal. In some cases, to communicate the RFID signal, the second antenna is configured to receive an additional RFID signal from a RFID energy harvesting device. In some examples, the RFID signal can be a RFID continuous wave transmission that is configured to maintain one or more RFID energy harvesting devices in an awake state. In some examples, the RFID signal can include an RFID inventory sequence, a RFID select sequence, and/or a RFID access sequence.

In some cases, a computing device (or component thereof) (e.g., the wireless device 407 of FIG. 4, the computing device configured to perform the operations of the process 1500 of FIG. 15, the computing system 1600 of FIG. 16, etc.) can configure a first antenna to communicate RFID signals. During a first period of time, the computing device (or component thereof) can communicate, using the first antenna, a first RFID signal. The first period of time can correspond to a WWAN paging interval that occurs during an idle state, a CRDX inactive state, a WWAN Discontinuous Reception (DRX) sleep state an Extended DRX (eDRX) state, an Idle mode-Discontinuous Reception (IDRX) state, etc. The computing device (or component thereof) can reconfigure the first antenna to receive WWAN signals and establish a WWAN session with a network entity (e.g., a base station, such as an eNB, gNB, etc., or a portion of the base station such as a CU, a DU, a RU, a Near-RT RIC, or a Non-RT RIC of a disaggregated base station). During a second period of time after the first period of time, the computing device (or component thereof) can communicate, using the first antenna, a first WWAN signal and process the first WWAN signal. In some cases, to communicate the first RFID signal, the first antenna is configured to receive the first RFID signal from a RFID energy harvesting device or to transmit the first RFID signal to the RFID energy harvesting device. In some cases, to communicate the first WWAN signal, the first antenna is configured to receive the first WWAN signal or to transmit the first WWAN signal. In some examples, the computing device (or component thereof) can establish a WWAN session with a second network entity. During a third period of time subsequent to the second period of time, the first antenna can communicate a second WWAN signal to the second network entity. The computing device (or component thereof) can process the second WWAN signal. In some aspects, to communicate the second WWAN signal, the first antenna is configured to receive the second WWAN signal or transmit the second WWAN signal.

In some cases, a computing device (or component thereof) (e.g., the wireless device 407 of FIG. 4, the computing device configured to perform the operations of the process 1500 of FIG. 15, the computing system 1600 of FIG. 16, etc.) can configure a first antenna for transmission of RFID signals and configure a second antenna for transmission of WWAN signals. The computing device (or component thereof) can establish a WWAN session with a first network entity (e.g., a base station, such as an eNB, gNB, etc., or a portion of the base station such as a CU, a DU, a RU, a Near-RT RIC, or a Non-RT RIC of a disaggregated base station). During a first period of time, the computing device (or component thereof) can communicate, using the first antenna, a first RFID signal and communicate, using the second antenna, a first WWAN signal with the first network entity. The computing device (or component thereof) can establish a WWAN session with a second network entity. During a second period of time, the computing device (or component thereof) can communicate, using the first antenna, a second WWAN signal with the second network entity. In some examples, the second period of time occurs subsequent to an end of the first period of time. In some cases, to communicate the RFID signal, the first antenna can receive the RFID signal from a RFID energy harvesting device, to communicate the first WWAN signal, the second antenna can receive the first WWAN signal and, to communicate the second WWAN signal, the second antenna can receive the second WWAN signal. In some cases, to communicate the RFID signal, the first antenna is configured to transmit the RFID signal to an RFID energy harvesting device, to communicate the first WWAN signal, the second antenna is configured to transmit the first WWAN signal to the first network entity and/or receive the first WWAN signal from the first network entity and, to communicate the second WWAN signal, the second antenna is configured to transmit the second WWAN signal to the second network entity. In some aspects, during the first period of time, the computing device (or component thereof) can identify that a WWAN upload is required. The computing device (or component thereof) can interrupt communication of the RFID signal and can transmit, using the first antenna, WWAN communications.

In some cases, the computing device of process 1500 may include various components, such as one or more input devices, one or more output devices, one or more processors, one or more microprocessors, one or more microcomputers, one or more cameras, one or more sensors, and/or other component(s) that are configured to carry out the steps of processes described herein. The computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the Wi-Fi (802.11x) standards, data according to the Bluetooth™ standard, data according to the Internet Protocol (IP) standard, and/or other types of data.

The components of the computing device of process 1500 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 1500 is illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 1500 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 16 is a diagram illustrating an example of a system for physical layer concurrency management for RFID and WWAN communications. In particular, FIG. 16 illustrates an example of computing system 1600, which may be for example any computing device making up internal computing system, a remote computing system, a camera, or any component thereof in which the components of the system are in communication with each other using connection 1605. Connection 1605 may be a physical connection using a bus, or a direct connection into processor 1610, such as in a chipset architecture. Connection 1605 may also be a virtual connection, networked connection, or logical connection.

In some aspects, computing system 1600 is a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

Example system 1600 includes at least one processing unit (CPU or processor) 1610 and connection 1605 that communicatively couples various system components including system memory 1615, such as read-only memory (ROM) 1618 and random access memory (RAM) 1625 to processor 1610. Computing system 1600 may include a cache 1612 of high-speed memory connected directly with, in close proximity to, or integrated as part of processor 1610.

Processor 1610 may include any general-purpose processor and a hardware service or software service, such as services 1632, 1634, and 1636 stored in storage device 1630, configured to control processor 1610 as well as a special-purpose processor where software instructions are incorporated into the actual processor design. Processor 1610 may essentially be a completely self-contained computing system, containing multiple cores or processors, a bus, memory controller, cache, etc. A multi-core processor may be symmetric or asymmetric.

To enable user interaction, computing system 1600 includes an input device 1645, which may represent any number of input mechanisms, such as a microphone for speech, a touch-sensitive screen for gesture or graphical input, keyboard, mouse, motion input, speech, etc. Computing system 1600 may also include output device 1635, which may be one or more of a number of output mechanisms. In some instances, multimodal systems may enable a user to provide multiple types of input/output to communicate with computing system 1600.

Computing system 1600 may include communications interface 1640, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wiredport/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1640 may also include one or more Global Navigation Satellite System (GNSS) receivers or transceivers that are used to determine a location of the computing system 1600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1630 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1630 may include software services, servers, services, etc., that when the code that defines such software is executed by the processor 1610, it causes the system to perform a function. In some aspects, a hardware service that performs a particular function may include the software component stored in a computer-readable medium in connection with the necessary hardware components, such as processor 1610, connection 1605, output device 1635, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B.

Claim language or other language reciting “at least one processor configured to,” “at least one processor being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Illustrative aspects of the disclosure include:
Aspect 1. An apparatus for wireless communications, the apparatus comprising: a memory; and a processor coupled to the memory and configured to: determine, based on constraints on resources of the apparatus, a schedule for radio frequency identification (RFID) operations and wireless wide area network (WWAN) operations on the apparatus, wherein the resources comprise at least one of compute resources or radio frequency (RF) component resources; and perform, based on the schedule, the RFID operations and the WWAN operations on the apparatus.
Aspect 2. The apparatus of Aspect 1, wherein the processor is further configured to determine the schedule based on whether the apparatus comprises a single subscriber identity module (SSIM) or multiple subscriber identity modules (MSIM).
Aspect 3. The apparatus of Aspect 2, wherein the apparatus comprises the MSIM, and wherein the WWAN operations comprise first WWAN operations and second WWAN operations.
Aspect 4. The apparatus of Aspect 3, wherein the schedule indicates simultaneous performance of at least some of the RFID operations, the first WWAN operations, and the second WWAN operations.
Aspect 5. The apparatus of any of Aspects 1 to 4, wherein, based on the resources being constrained, the schedule indicates performance of the WWAN operations using new radio (NR) communications or long-term evolution (LTE) communications.
Aspect 6. The apparatus of any of Aspects 1 to 5, wherein, based on the resources being constrained, the schedule indicates performance of the WWAN operations using frequency range one (FR1) or frequency range two (FR2) of new radio (NR) communications.
Aspect 7. The apparatus of any of Aspects 1 to 6, wherein, based on the resources being constrained, the schedule indicates performance of the WWAN operations using a reduced number of carriers from a total number of carriers available for WWAN communications.
Aspect 8. The apparatus of any of Aspects 1 to 7, wherein the schedule indicates performance of the RFID operations during one or more sleep durations for the WWAN operations.
Aspect 9. The apparatus of any of Aspects 1 to 8, wherein the schedule indicates performance of the RFID operations during one or more paging intervals for the WWAN operations.
Aspect 10. The apparatus of any of Aspects 1 to 9, wherein the processor is further configured to determine the schedule based on performance of the RFID operations having priority over performance of the WWAN operations.
Aspect 11. The apparatus of any of Aspects 1 to 10, wherein the RFID operations comprise RFID receive operations and RFID transmit operations, and wherein the WWAN operations comprise WWAN receive operations or WWAN transmit operations.
Aspect 12. The apparatus of any of Aspects 1 to 11, wherein the schedule indicates time division multiplexing (TDM) of the RFID operations and the WWAN operations based on at least the RF component resources being constrained.
Aspect 13. The apparatus of Aspect 12, wherein the TDM comprises scheduling the RFID operations and the WWAN operations in different time slots.
Aspect 14. The apparatus of Aspect 12, wherein the apparatus comprises multiple subscriber identity modules (SIMs), each SIM of the multiple SIMs including a corresponding operation stack, and wherein the time division multiplexing comprises scheduling RFID operations and operations of each operation stack in different timeslots.
Aspect 15. The apparatus of any of Aspects 1 to 14, wherein the RF component resources comprise at least one of an antenna, a filter, an amplifiers, a transceiver, or a switch.
Aspect 16. The apparatus of any of Aspects 1 to 15, wherein the compute resources comprise modem baseband resources.
Aspect 17. The apparatus of any of Aspects 1 to 16, wherein the apparatus is user equipment (UE).
Aspect 18. A method of wireless communications, the method comprising: determining, based on constraints on resources of a user device, a schedule for radio frequency identification (RFID) operations and wireless wide area network (WWAN) operations on the user device, wherein the resources comprise at least one of compute resources or radio frequency (RF) component resources; and performing, based on the schedule, the RFID operations and the WWAN operations on the user device.
Aspect 19. The method of Aspect 18, further comprising determining the schedule based on whether the user device comprises a single subscriber identity module (SSIM) or multiple subscriber identity modules (MSIM).
Aspect 20. The method of Aspect 19, wherein the user device comprises the MSIM, and wherein the WWAN operations comprise first WWAN operations and second WWAN operations.
Aspect 21. The method of Aspect 20, wherein the schedule indicates simultaneous performance of at least some of the RFID operations, the first WWAN operations, and the second WWAN operations.
Aspect 22. The method of any of Aspects 18 to 21, wherein, based on the resources being constrained, the schedule indicates performance of the WWAN operations using new radio (NR) communications or long-term evolution (LTE) communications.
Aspect 23. The method of any of Aspects 18 to 22, wherein, based on the resources being constrained, the schedule indicates performance of the WWAN operations using frequency range one (FR1) or frequency range two (FR2) of new radio (NR) communications.
Aspect 24. The method of any of Aspects 18 to 23, wherein, based on the resources being constrained, the schedule indicates performance of the WWAN operations using a reduced number of carriers from a total number of carriers available for WWAN communications.
Aspect 25. The method of any of Aspects 18 to 24, wherein the schedule indicates performance of the RFID operations during one or more sleep durations for the WWAN operations.
Aspect 26. The method of any of Aspects 18 to 25, wherein the schedule indicates performance of the RFID operations during one or more paging intervals for the WWAN operations.
Aspect 27. The method of any of Aspects 18 to 26, further comprising determining the schedule based on performance of the RFID operations having priority over performance of the WWAN operations.
Aspect 28. The method of any of Aspects 18 to 27, wherein the RFID operations comprise RFID receive operations and RFID transmit operations, and wherein the WWAN operations comprise WWAN receive operations or WWAN transmit operations.
Aspect 29. The method of any of Aspects 18 to 28, wherein the schedule indicates time division multiplexing (TDM) of the RFID operations and the WWAN operations based on at least the RF component resources being constrained.
Aspect 30. The method of Aspect 29, wherein the TDM comprises scheduling the RFID operations and the WWAN operations in different time slots.
Aspect 31. The method of Aspect 29, wherein the user device comprises multiple subscriber identity modules (SIMs), each SIM of the multiple SIMs including a corresponding operation stack, and wherein the time division multiplexing comprises scheduling RFID operations and operations of each operation stack in different timeslots.
Aspect 32. The method of any of Aspects 18 to 31, wherein the RF component resources comprise at least one of an antenna, a filter, an amplifiers, a transceiver, or a switch.
Aspect 33. The method of any of Aspects 18 to 32, wherein the compute resources comprise modem baseband resources.
Aspect 34. An apparatus for wireless communications, comprising: at least one memory; and at least one processor coupled to the at least one memory and configured to: configure a first antenna to communicate Wireless Wide Area Network (WWAN) signals; establish a WWAN session with a network entity; configure a second antenna to communicate Radio Frequency Identification (RFID) signals; cause the first antenna to communicate a WWAN signal with the network entity; and cause the second antenna to communicate a RFID signal.
Aspect 35. The apparatus of Aspect 34, wherein: to communicate the WWAN signal, the first antenna is configured to receive the WWAN signal from the network entity; and to communicate the RFID signal, the second antenna is configured to transmit the RFID signal to an energy harvesting device.
Aspect 36. The apparatus of Aspect 35, wherein the at least one processor is configured to: configure a third antenna to communicate WWAN signals; establish a second WWAN session with a second network entity; cause the third antenna to communicate a second WWAN signal from the second network entity; and process the second WWAN signal.
Aspect 37. The apparatus of any of Aspects 34 to 36, wherein: to communicate the RFID signal, the second antenna is configured to receive an additional RFID signal from a RFID energy harvesting device.
Aspect 38. The apparatus of any of Aspects 34 to 37, wherein the RFID signal is a RFID continuous wave transmission that is configured to maintain one or more RFID energy harvesting devices in an awake state.
Aspect 39. The apparatus of any of Aspects 34 to 38, wherein the RFID signal comprises one or more of: a RFID inventory sequence, a RFID select sequence, and a RFID access sequence.
Aspect 40. The apparatus of any of Aspects 34 to 39, wherein the RFID signal comprises a continuous wave transmission.
Aspect 41. An apparatus for wireless communications, comprising: at least one memory; and at least one processor coupled to the at least one memory and configured to: configure a first antenna for transmission of Radio Frequency Identification (RFID) signals; during a first period of time, cause the first antenna to communicate a first RFID signal; reconfigure the first antenna to communicate WWAN signals; establish a WWAN session with a network entity; and during a second period of time subsequent to the first period of time, cause the first antenna to communicate a first WWAN signal and process the first WWAN signal.
Aspect 42. The apparatus of Aspect 41, wherein: to communicate the first RFID signal, the first antenna is configured to receive the first RFID signal from a RFID energy harvesting device or to transmit the first RFID signal to the RFID energy harvesting device; and to communicate the first WWAN signal, the first antenna is configured to receive the first WWAN signal or to transmit the first WWAN signal.
Aspect 43. The apparatus of any of Aspects 41 or 42, wherein the at least one processor is configured to: establish a WWAN session with a second network entity; during a third period of time subsequent to the second period of time, cause the first antenna to communicate a second WWAN signal to the second network entity; and process the second WWAN signal.
Aspect 44. The apparatus of Aspect 43, wherein, to communicate the second WWAN signal, the first antenna is configured to receive the second WWAN signal.
Aspect 45. The apparatus of Aspect 43, wherein, to communicate the second WWAN signal, the first antenna is configured to transmit the second WWAN signal.
Aspect 46. The apparatus of any of Aspects 41 to 45, wherein the first period of time corresponds to a WWAN paging interval that occurs during an idle state.
Aspect 47. The apparatus of any of Aspects 41 to 46, wherein the first period of time corresponds to a CRDX inactive state.
Aspect 48. The apparatus of any of Aspects 41 to 47, wherein the first period of time corresponds to WWAN Discontinuous Reception (DRX) sleep state an Extended DRX (eDRX) state or an Idle mode-Discontinuous Reception (IDRX) state.
Aspect 49. An apparatus for wireless communications, comprising: at least one memory; and at least one processor coupled to the at least one memory and configured to: configure a first antenna for transmission of RFID signals; configure a second antenna for transmission of WWAN signals; establish a WWAN session with a first network entity; during a first period of time, cause the first antenna to communicate a RFID signal and cause the second antenna to communicate a first WWAN signal with the first network entity; establish a WWAN session with a second network entity; and during a second period of time, cause the second antenna to communicate a second WWAN signal with the second network entity.
Aspect 50. The apparatus of Aspect 49, wherein: to communicate the RFID signal, the first antenna is configured to receive the RFID signal from a RFID energy harvesting device; to communicate the first WWAN signal, the second antenna is configured to receive the first WWAN signal; and to communicate the second WWAN signal, the second antenna is configured to receive the second WWAN signal.
Aspect 51. The apparatus of any of Aspects 49 or 50, wherein: to communicate the RFID signal, the first antenna is configured to transmit the RFID signal to an RFID energy harvesting device; to communicate the first WWAN signal, the second antenna is configured to perform one or more of: transmitting the first WWAN signal to the first network entity and receiving the first WWAN signal from the first network entity; and to communicate the second WWAN signal, the second antenna is configured to transmit the second WWAN signal to the second network entity.
Aspect 52. The apparatus of any of Aspects 49 to 51, wherein, during the first period of time, the at least one processor is configured to: identify that a WWAN upload is required; interrupt communication of the RFID signal; and cause the first antenna to transmit WWAN communications.
Aspect 53. The apparatus of any of Aspects 49 to 52, wherein the second period of time occurs subsequent to an end of the first period of time.
Aspect 54. A method for wireless communications, the method comprising: configuring an antenna to receive Wireless Wide Area Network (WWAN) signals; establishing a WWAN session with a network entity; causing the antenna to communicate a WWAN signal with the network entity; configuring the antenna to receive Radio Frequency Identification (RFID) signals; and causing the antenna to communicate a RFID signal.
Aspect 55. The method of Aspect 54, further comprising disconnecting the WWAN session prior to configuring the antenna to receive RFID signals.
Aspect 56. The method of any of Aspects 54 or 55, wherein disconnecting the WWAN session comprises performing one or more of: forcing a Radio Link failure in a download or ceasing an upload.
Aspect 57. A method for wireless communications, the method comprising: configuring a first antenna and a second antenna to receive Wireless Wide Area Network (WWAN) signals; establishing a WWAN session with a network entity; causing the first antenna and the second antenna to communicate WWAN signals with the network entity; configuring the second antenna to receive Radio Frequency Identification (RFID) signals; and causing the second antenna to communicate a RFID signal.
Aspect 58. A method for wireless communications, the method comprising: configuring a first antenna and a second antenna to receive Wireless Wide Area Network (WWAN) signals; establishing a first WWAN session with a first network entity and a second WWAN session with a second network entity; during a first period of time, causing the first antenna to communicate a first WWAN signal with the first network entity and causing the second antenna to communicate a second WWAN signal with the second network entity; reconfiguring the second antenna to communicate RFID signals; and during a second period of time, causing the second antenna to communicate an RFID signal with an RFID device.
Aspect 59. A method for wireless communications, the method comprising: configuring a first antenna to communicate Wireless Wide Area Network (WWAN) signals; establishing a WWAN session with a network entity; configuring a second antenna to communicate Radio Frequency Identification (RFID) signals; causing the first antenna to communicate a WWAN signal with the network entity; and causing the second antenna to communicate a RFID signal.
Aspect 60. The method of Aspect 59, wherein: to communicate the WWAN signal, the first antenna is configured to receive the WWAN signal from the network entity; and to communicate the RFID signal, the second antenna is configured to receive the RFID signal from a RFID energy harvesting device.
Aspect 61. The method of any of Aspects 59 or 60, further comprising: configuring a third antenna to communicate WWAN signals; establishing a second WWAN session with a second network entity; causing the third antenna to communicate a second WWAN signal from the second network entity; and processing the second WWAN signal.
Aspect 62. The method of any of Aspects 59 to 61, wherein, to communicate the RFID signal, the second antenna is configured to receive the RFID signal to from a RFID energy harvesting device.
Aspect 63. The method of any of Aspects 59 to 62, wherein the RFID signal is a RFID continuous wave transmission that is configured to maintain one or more RFID energy harvesting devices in an awake state.
Aspect 64. The method of any of Aspects 59 to 63, wherein the RFID signal comprises one or more of: a RFID inventory sequence a RFID select sequence, and a RFID access sequence.
Aspect 65. The method of Aspect 64, wherein the RFID inventory sequence comprises a continuous wave transmission.
Aspect 66. A method for wireless communications, the method comprising: configuring a first antenna for transmission of Radio Frequency Identification (RFID) signals; during a first period of time, causing the first antenna to communicate a first RFID signal; reconfiguring the first antenna to communicate WWAN signals; establishing a WWAN session with a network entity; and during a second period of time subsequent to the first period of time, causing the first antenna to communicate a first WWAN signal and process the first WWAN signal.
Aspect 67. The method of Aspect 66, wherein: to communicate the first RFID signal, the first antenna is configured to receive the first RFID signal from a RFID energy harvesting device or to transmit the first RFID signal to the RFID energy harvesting device; and to communicate the first WWAN signal, the first antenna is configured to receive the first WWAN signal or to transmit the first WWAN signal.
Aspect 68. The method of any of Aspects 66 or 67, further comprising: establishing a WWAN session with a second network entity; during a third period of time subsequent to the second period of time, causing the first antenna to communicate a second WWAN signal to the second network entity; and processing the second WWAN signal.
Aspect 69. The method of Aspect 68, wherein communicating the second WWAN signal via the first antenna comprises receiving the second WWAN signal.
Aspect 70. The method of Aspect 68, wherein communicating the second WWAN signal via the first antenna comprises transmitting the second WWAN signal.
Aspect 71. The method of any of Aspects 66 to 70, wherein the first period of time corresponds to a WWAN paging interval that occurs during an idle state.
Aspect 72. The method of any of Aspects 66 to 71, wherein the first period of time corresponds to a CRDX inactive state.
Aspect 73. The method of any of Aspects 66 to 72, wherein the first period of time corresponds to WWAN Discontinuous Reception (DRX) sleep state an Extended DRX (eDRX) state or an Idle mode-Discontinuous Reception (IDRX) state.
Aspect 74. A method for wireless communications, the method comprising: configuring a first antenna for transmission of RFID signals; configuring a second antenna for transmission of WWAN signals; establishing a WWAN session with a first network entity; during a first period of time, causing the first antenna to communicate a RFID signal and causing the second antenna to communicate a first WWAN signal with the first network entity; establishing a WWAN session with a second network entity; and during a second period of time, causing the second antenna to communicate a second WWAN signal with the second network entity.
Aspect 75. The method of Aspect 74, wherein: to communicate the RFID signal, the first antenna is configured to receive the RFID signal from a RFID energy harvesting device; to communicate the first WWAN signal, the second antenna is configured to receive the first WWAN signal; and to communicate the second WWAN signal, the second antenna is configured to receive the second WWAN signal.
Aspect 76. The method of any of Aspects 74 or 75, wherein: to communicate the RFID signal, the first antenna is configured to transmit the RFID signal to an RFID energy harvesting device; to communicate the first WWAN signal, the second antenna is configured to perform one or more of: transmitting the first WWAN signal to the first network entity and receiving the first WWAN signal from the first network entity; and to communicate the second WWAN signal, the second antenna is configured to transmit the second WWAN signal to the second network entity.
Aspect 77. The method of any of Aspects 74 to 76, further comprising: during the first period of time, identifying that a WWAN upload is required, interrupting communication of the RFID signal, and causing the first antenna to transmit WWAN communications.
Aspect 78. The method of any of Aspects 74 to 77, wherein the second period of time occurs subsequent to an end of the first period of time.
Aspect 79. A method for wireless communications, the method comprising: configuring an antenna to receive Wireless Wide Area Network (WWAN) signals; establishing a WWAN session with a network entity; causing the antenna to communicate a WWAN signal with the network entity; configuring the antenna to receive Radio Frequency Identification (RFID) signals; and causing the antenna to communicate a RFID signal.
Aspect 80. The method of Aspect 79, further comprising disconnecting the WWAN session prior to configuring the antenna to receive RFID signals.
Aspect 81. The method of any of Aspects 79 or 80, wherein disconnecting the WWAN session comprises performing one or more of: forcing a Radio Link failure in a download or ceasing an upload.
Aspect 82. A non-transitory computer-readable medium having stored thereon instructions that, when executed by at least one processor, cause the at least one processor to perform operations according to any one or more of Aspects 18 to 33.
Aspect 83. An apparatus including one or more means for performing operations according to any one or more of Aspects 18 to 33.
Aspect 84. A non-transitory computer-readable medium having stored thereon instructions that, when executed by at least one processor, cause the at least one processor to perform operations according to any one or more of Aspects 34 to 81.
Aspect 85. An apparatus including one or more means for performing operations according to any one or more of Aspects 34 to 81.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. An apparatus for wireless communications, the apparatus comprising:
a memory; and
a processor coupled to the memory and configured to:
determine, based on constraints on resources of the apparatus, a schedule for radio frequency identification (RFID) operations and wireless wide area network (WWAN) operations on the apparatus, wherein the resources comprise at least one of compute resources or radio frequency (RF) component resources; and
perform, based on the schedule, the RFID operations and the WWAN operations on the apparatus.

2. The apparatus of claim 1, wherein the processor is further configured to determine the schedule based on whether the apparatus comprises a single subscriber identity module (SSIM) or multiple subscriber identity modules (MSIM).

3. The apparatus of claim 2, wherein the apparatus comprises the MSIM, and wherein the WWAN operations comprise first WWAN operations and second WWAN operations.

4. The apparatus of claim 3, wherein the schedule indicates simultaneous performance of at least some of the RFID operations, the first WWAN operations and the second WWAN operations.

5. The apparatus of claim 1, wherein, based on the resources being constrained, the schedule indicates performance of the WWAN operations using new radio (NR) communications or long-term evolution (LTE) communications.

6. The apparatus of claim 1, wherein, based on the resources being constrained, the schedule indicates performance of the WWAN operations using frequency range one (FR1) or frequency range two (FR2) of new radio (NR) communications.

7. The apparatus of claim 1, wherein, based on the resources being constrained, the schedule indicates performance of the WWAN operations using a reduced number of carriers from a total number of carriers available for WWAN communications.

8. The apparatus of claim 1, wherein the schedule indicates performance of the RFID operations during one or more sleep durations for the WWAN operations.

9. The apparatus of claim 1, wherein the schedule indicates performance of the RFID operations during one or more paging intervals for the WWAN operations.

10. The apparatus of claim 1, wherein the processor is further configured to determine the schedule based on performance of the RFID operations having priority over performance of the WWAN operations.

11. The apparatus of claim 1, wherein the RFID operations comprise RFID receive operations and RFID transmit operations, and wherein the WWAN operations comprise WWAN receive operations or WWAN transmit operations.

12. The apparatus of claim 1, wherein the schedule indicates time division multiplexing (TDM) of the RFID operations and the WWAN operations based on at least the RF component resources being constrained.

13. The apparatus of claim 12, wherein the TDM comprises scheduling the RFID operations and the WWAN operations in different time slots.

14. The apparatus of claim 12, wherein the apparatus comprises multiple subscriber identity modules (SIMs), each SIM of the multiple SIMs including a corresponding operation stack, and wherein the time division multiplexing comprises scheduling RFID operations and operations of each operation stack in different timeslots.

15. The apparatus of claim 1, wherein the RF component resources comprise at least one of an antenna, a filter, an amplifier, a transceiver, or a switch.

16. The apparatus of claim 1, wherein the compute resources comprise modem baseband resources.

17. The apparatus of claim 1, wherein the apparatus is user equipment (UE).

18. A method of wireless communications, the method comprising:
determining, based on constraints on resources of a user device, a schedule for radio frequency identification (RFID) operations and wireless wide area network (WWAN) operations on the user device, wherein the resources comprise at least one of compute resources or radio frequency (RF) component resources; and
performing, based on the schedule, the RFID operations and the WWAN operations on the user device.

19. The method of claim 18, further comprising determining the schedule based on whether the user device comprises a single subscriber identity module (SSIM) or multiple subscriber identity modules (MSIM).

20. The method of claim 19, wherein the user device comprises the MSIM, and wherein the WWAN operations comprise first WWAN operations and second WWAN operations.

21. The method of claim 20, wherein the schedule indicates simultaneous performance of at least some of the RFID operations, the first WWAN operations, and the second WWAN operations.

22. The method of claim 18, wherein, based on the resources being constrained, the schedule indicates performance of the WWAN operations using new radio (NR) communications or long-term evolution (LTE) communications.

23. The method of claim 18, wherein, based on the resources being constrained, the schedule indicates performance of the WWAN operations using frequency range one (FR1) or frequency range two (FR2) of new radio (NR) communications.

24. The method of claim 18, wherein, based on the resources being constrained, the schedule indicates performance of the WWAN operations using a reduced number of carriers from a total number of carriers available for WWAN communications.

25. The method of claim 18, wherein the schedule indicates performance of the RFID operations during one or more sleep durations for the WWAN operations.

26. The method of claim 18, wherein the schedule indicates performance of the RFID operations during one or more paging intervals for the WWAN operations.

27. The method of claim 18, further comprising determining the schedule based on performance of the RFID operations having priority over performance of the WWAN operations.

28. The method of claim 18, wherein the RFID operations comprise RFID receive operations and RFID transmit operations, and wherein the WWAN operations comprise WWAN receive operations or WWAN transmit operations.

29. The method of claim 18, wherein the schedule indicates time division multiplexing (TDM) of the RFID operations and the WWAN operations based on at least the RF component resources being constrained.

30. The method of claim 29, wherein the TDM comprises scheduling the RFID operations and the WWAN operations in different time slots.
